(19) United States
(12) Patent Application Publication
(10) Pub. No.: US 2026/0150063 A1
(43) Pub. Date: May 28, 2026

(54) SYSTEMS, METHODS, AND DEVICES FOR STAGGERING DUTY CYCLES ACROSS COMPONENT CARRIERS

(71) Applicant: Apple Inc., Cupertino, CA (US)

(72) Inventors: Srinivasan BALASUBRAMANIAN, San Diego, CA (US); Tarik TABET, Carlsbad, CA (US); Sairamesh NAMMI, San Diego, CA (US); Sreevalsan VALLATH, Dublin, CA (US)

(21) Appl. No.: 19/396,237

(22) Filed: Nov. 20, 2025

Related U.S. Application Data
(60) Provisional application No. 63/724,206, filed on Nov. 22, 2024.

(51) Int. Cl. H04W 56/00

(52) U.S. Cl. CPC H04W 56/001

(57) ABSTRACT

The techniques described herein can include solutions for staggering duty cycles across component carriers (CCs) of a CC group. A user equipment (UE) can receive synchronization signal blocks (SSBs) from one or more base stations via a CC group for SSB according to a duty cycle. The UE can receive a first SSB via a first CC and receive a second SSB via a second CC according to the duty cycle of the CC group for SSB. The UE can perform one or more synchronization operations using the first SSB or the second SSB. Additionally, or alternatively, the UE can be configured to receive channel state information (CSI) reference signals (CSI-RSs) from the one or more base stations via another CC group for CSI-RS according to another duty cycle. The UE can perform mobility measurements using the CSI-RSs to determine mobility information associated with the CC group for CSI-RS.

### CROSS-REFERENCE TO RELATED APPLICATIONS

This application claims the benefit of U.S. Provisional Application No. 63/724,206, filed Nov. 22, 2024, the content of which is herein incorporated by reference in its entirety for all purposes.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks can be developed to implement fourth generation (4G), fifth generation (5G) or new radio (NR) technology. Such technology can include solutions for increasing network energy savings by staggering duty cycles across component carriers (CCs) of a group of CCs. Some scenarios can involve communicating synchronization signal blocks (SSBs) and/or channel state information (CSI) reference signals (CSI-RSs) associated with the group of CCs, such that a user equipment (UE) can leverage the SSBs or the CSI-RSs communicated via a single CC for the group of CCs.

### BRIEF DESCRIPTION OF THE DRAWINGS

The present disclosure will be readily understood and enabled by the detailed description and accompanying figures of the drawings. Like reference numerals can designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and can mean at least one, one or more, etc.

FIG. 1 is a diagram of an example of an overview according to one or more implementations described herein.

FIG. 2 is a diagram of an example network according to one or more implementations described herein.

FIG. 3 is a diagram of an example a master cell group (MCG) and a secondary cell group (SCG) according to one or more implementations described herein.

FIG. 4 is a diagram of an example process for staggering a system synchronization block (SSB) duty cycle across component carries (CCs) of a CC group for SSB according to one or more implementations described herein.

FIG. 5 is a diagram of an example process for staggering a channel state information (CSI) reference signal (RS) (CSI-RS) duty cycle across CCs of a CC group for CSI-RS according to one or more implementations described herein.

FIG. 6 is a diagram of example CC group layouts according to one or more implementations described herein.

FIG. 7 is a diagram of an example of signal timing according to one or more implementations described herein.

FIG. 8 is a diagram of an example of signal timing according to one or more implementations described herein.

FIG. 9 is a diagram of an example of a data structure for transmissions according to one or more implementations described herein.

FIG. 10 is a diagram of an example of a data structure for mobility measurements according to one or more implementations described herein.

FIG. 11 is a diagram of an example a data structure for reporting according to one or more implementations described herein.

FIG. 12 is a diagram of an example of components of a device according to one or more implementations described herein.

FIG. 13 is a diagram of example interfaces of baseband circuitry according to one or more implementations described herein.

FIG. 14 is a block diagram illustrating components, according to one or more implementations described herein, able to read instructions from a machine-readable or computer-readable medium (e.g., a non-transitory machine-readable storage medium) and perform any one or more of the methodologies discussed herein.

FIG. 15 is a diagram of an example process for staggering a duty cycle across CCs of a CC group for SSB according to one or more implementations described herein.

FIG. 16 is a diagram of an example process for staggering a duty cycle across CCs of a CC group for CSI-RS according to one or more implementations described herein.

FIG. 17 is a diagram of an example process for staggering a duty cycle across CCs of a CC group for SSB according to one or more implementations described herein.

FIG. 18 is a diagram of an example process for staggering a duty cycle across CCs of a CC group for CSI-RS according to one or more implementations described herein.

### DETAILED DESCRIPTION

The following detailed description refers to the accompanying drawings. Like reference numbers in different drawings can identify the same or similar features, elements, operations, etc. Additionally, the present disclosure is not limited to the following description as other implementations can be utilized, and structural or logical changes made, without departing from the scope of the present disclosure.

Telecommunication networks can include user equipment (UEs) capable of communicating with base stations and/or other network access nodes. UEs and base stations can implement various techniques and communications standards for enabling UEs and base stations to discover one another, establish and maintain connectivity, and exchange information in an ongoing manner. Objectives of such techniques can include staggering duty cycles across component carriers (CCs) of a CC group (e.g., a CC group for SSB, a CC group for CSI-RS).

A UE can be configured to communicate with one or more cells (e.g., primary cells, secondary cells, neighboring cells) associated with one or more base stations (e.g., radio access network (RAN) nodes) via one or more CCs (e.g., a set of frequency and time domain resources). In some scenarios, to establish and maintain a connection with one or more cells, synchronization signal blocks (SSBs) can be communicated between the one or more cells and the UE via the one or more CCs. For example, the UE can be camped (e.g., in an IDLE mode, INACTIVE mode, or another type of power saving mode) while in a particular cell and receive SSBs from each CC associated with the cell. SSB transmissions can be subject to a duty cycle associated with the CC. For example, a duty cycle for an SSB can involve transmitting a series of SSBs via a CC in accordance with a periodicity separating each SSB of the series.

In other examples, the UE can operate in a connected mode (e.g., active, mobile) with one or more cells and receive SSBs from each CC associated with the one or more cells. In some scenarios, a network can operate individual CCs in an isolated manner such that SSBs can be communicated via CCs independently (e.g., each CC can communicate a respective SSB between the respective cell and the UE). In some such scenarios, the SSBs associated with a respective CC can be communicated to the UE in accordance with a periodicity (e.g., repetition interval) to support establishing connection to the respective cell (e.g., finding the cell), camping (e.g., idling at a cell), maintaining transport overhead (TO) and frame overhead (FO), performing page monitoring, and providing idle mobility support.

However, operating individual CCs in an isolated manner can cause each CC in a set of CCs to communicate respective SSBs between a quantity of UEs and the one or more cells, which can negatively affect network energy savings (NES). For example, because each CC is associated with transmitting respective SSBs to a UE, the corresponding set of CCs can be associated with relatively high network energy usage and resource consumption. In some scenarios, to reduce the negative impact of operating individual CCs in an isolated manner, a network can implement relatively fewer SSBs (e.g., refraining from communicating SSBs) over the set of CCs, discontinuous transmission and reception (e.g., cell DTX, cell DRX), or channel state information (CSI) enhancements for beam management by adapting the spatial and power domain transmission of the CSI reference signals (CSI-RS). Similar to SSB transmissions, CSI-RS transmissions and other operations can be subject to a duty cycle. A duty cycle for an CSI-RS can involve transmitting a series of CSI-RS via a CC in accordance with a periodicity separating each CSI-RS of the series. As such a duty cycle, as referred to herein, can pertain to SSB transmissions, CSI-RS transmissions, a combination thereof, or another type of transmission such as channel quality indicator (CQI) transmissions.

However, in some such scenarios, UEs may not be compatible with such mitigation strategies, or the mitigation strategies can be more focused on downlink communications than a network can support, which can limit commercial deployment of such mitigation strategies.

One or more of the techniques described herein address the foregoing deficiencies by providing solutions for staggering duty cycles associated with a group of CCs (e.g., a CC group) to support increased NES. For example, a network can operate a CC group for SSB in a collaborative manner to reduce a quantity of SSBs transmitted on individual CCs of the CC group for SSB. That is, a UE can use an SSB communicated via a single CC of the CC group for SSB to establish and maintain a connection to the one or more cells associated with the CC group for SSB.

In some scenarios, the UE can leverage the SSB communicated along an individual CC to maintain connectivity associated with the CC group for SSB, which can support increased NES by conserving resources otherwise associated with the UE using SSBs from each CC of the CC group for SSB. That is, the network can configure the CC group for SSB such that SSBs are communicated via individual CCs in a staggering schedule, which can reduce resource allocation associated with communicating the SSBs. In some scenarios, durations (e.g., time gaps) between communicating the SSBs according to the staggering schedule can be used to communicate other signaling (e.g., physical downlink shared channel (PDSCH)) with the UE, which can increase throughput for the network by leveraging the staggering schedule. In some scenarios, durations (e.g., time gaps, slots) between communicating the SSBs according to the staggering schedule can reduce resource consumption by the network, resulting in increased NES. The techniques described herein can address NES by implementing improvements to downlink and uplink communications that are compatible to UEs and therefore relevant to commercial deployment.

Additionally, or alternatively, a network can operate a CC group for CSI-RS in a collaborative manner regarding communicating CSI-RSs to support increased NES. A CSI-RS can be communicated to the UE to provide a reference signal for resources associated with a CC. Thus, implementing the techniques described herein can support a UE configured to use a CSI-RS communicated via a single CC of a CC group for CSI-RS to support measurements for mobility reporting. For example, the UE can leverage the CSI-RS communicated along an individual CC to determine mobility information associated with a CC group for CSI-RS, which can support increased NES by conserving resources otherwise associated with the UE using CSI-RSs from each CC of the CC group for CSI-RS. Similar to use with SSBs, the network can configure the CC group for CSI-RS such that CSI-RSs are communicated via individual CCs in a staggering schedule, which can reduce resource allocation associated with communicating CSI-RSs.

In some scenarios, after receiving the CSI-RSs via an individual CC, the UE can be configured to use the CSI-RS to perform measurement regarding mobility, such that the UE can identify mobility events associated with the one or more cells (e.g., corresponding to the CC group for CSI-RS). Because the UEs can support receiving a single CSI-RS for a CC group for CSI-RS, the network can support fewer transmissions of CSI-RSs along the CC group for CSI-RS, which can improve NES, among other advantages. Alternatively, durations (e.g., time gaps, slots) between communicating the CSI-RSs according to the staggering schedule can be used to communicate other signaling (e.g., PDSCH) with the UE, which can increase throughput for the network by leveraging the staggering schedule.

Further, the techniques described herein can involve the CC group for SSB and the CC group for CSI-RS being implemented using various deployment scenarios (e.g., horizontal deployment, vertical deployment), such that the UE can leverage SSBs or CSI-RSs transmitted along a single CC of the respective CC groups where the CC groups are associated with different cells including different footprints and different cell shaping or including cells with omni-sectors and multiple beams. For example, the CC group for SSB and the CC group for CSI-RS can each span a primary cell (PCell), a primary special cell (PSCell), a secondary cell (SCell), or a neighboring cell, or any combination thereof. In some such examples, the techniques described herein can support colocation and non-colocation of cells. Likewise, the CC group for SSB and the CC group for CSI-RS can each span one or more frequency division duplex (FDD) systems and/or one or more time division duplex (TDD) systems, each including one or more FDD cells and/or one or more TDD cells, respectively.

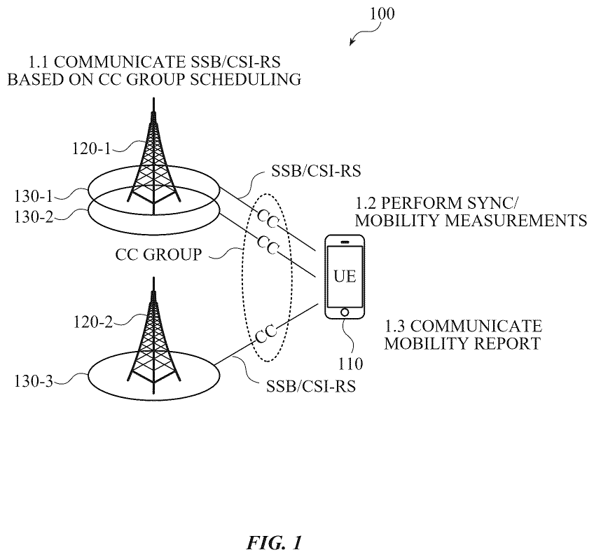

FIG. 1 is a diagram of an example of an overview 100 according to one or more implementations described herein. As shown, overview 100 can include UE 110, and one or more base stations 120 each associated with one or more CCs 130. For example, overview 100 includes base station 120-1 configured to communicate with UE 110 via CC 130-1 and/or CC 130-2, and base station 120-2 configured to communicate with UE 110 via CC 130-3.

In some scenarios, base station 120-1 and base station 120-2 can each be configured to operate as one or more cells, including a PCell, an SCell, a neighboring cell, a FDD cell, a TDD cell, an omni-sector cell, or any combination thereof. In some scenarios, UE 110 can be camped (e.g., idle, inactive) on (e.g., within) base station 120-1 (e.g., a coverage area of base station 120-1) or base station 120-2 (e.g., a coverage area of base station 120-2), or an overlapping area of coverage in which UE 110 is camped on both base station 120-1 and base station 120-2. In other scenarios, UE 110 can move between base station 120-1 and base station 120-2, such that UE 110 can be within a coverage area of base station 120-1 for a duration and transition to a coverage area of base station 120-2 for the duration. CCs 130 associated with base station 120-1 and/or base station 120-2 can be associated with a CC group (e.g., a CC group for SSB, a CC group for CSI-RS) operable to function in a collaborative manner, as described herein.

The CC group can be configured to communicate SSBs and/or CSI-RSs with UE 110 from base station 120-1, base station 120-2, or a combination thereof (at 1.1). For example, UE 110 can receive an SSB from base station 120-1 via CC 130-1 and use the SSB to establish and maintain a connection (e.g., to base station 120-1 and/or base station 120-2) via CC 130-1 or other CCs 130 (e.g., CC 130-2, CC 130-3) of the CC group for SSB. In some such examples, CC 130-1, CC 130-2, and CC 130-3 can form a CC group for SSB associated with base station 120-1 and base station 120-2 such that UE 110 can receive an SSB via one of CCs 130 and leverage the SSB to form and maintain a connection to either base station 120-1 or base station 120-2. In some scenarios, UE 110 can perform a synchronization operation with base station 120-1 or base station 120-2 using the SSB (at 1.2).

That is, UE 110 can opportunistically use CC 130 of the CC group (e.g., the CC group for SSB, the CC group for CSI-RS) rather than CC 130 associated with base station 120-1 on which UE 110 is camped. Likewise, UE 110 can receive a CSI-RS (at 1.1) from base station 120-1 via CC 130-1 and use the CSI-RS to perform measurements for the CC group for CSI-RS for determining mobility information (at 1.2) or detecting mobility events and reporting to base station 120-1 or base station 120-2 (at 1.3). In some scenarios, the CC group for SSB can be configured to communicate SSBs in accordance with a staggering schedule. For example, base station 120 (e.g., base station 120-1, base station 120-2) can transmit SSBs on each of CCs 130 of the CC group for SSB such that each SSB is offset in the time domain from the SSBs associate with other CCs 130 of the CC group for SSB. In some scenarios, the CC group for CSI-RS can be configured to communicated CSI-RSs in accordance with a different staggering schedule.

Operating CCs 130 in a collaborative manner can support NES for communicating SSBs to UE 110 (e.g., and other UEs of the network) or communicating CSI-RSs to UE 110 (e.g., and other UEs of the network). For example, SSBs or CSI-RSs can be communicated via CCs 130 of the respective CC group (e.g., the CC group for SSB, the CC group for CSI-RS) in a staggering schedule (e.g., a different staggering schedule for SSBs than a staggering schedule for CSI-RSs), which can support fewer transmissions for communicating SSBs or CSI-RSs to UE 110, without causing negative performance issues for UE 110. When factoring communicating SSBs or CSI-RSs to a quantity of UEs 110 by operating CCs 130 in the collaborative manner, the network can experience improved NES due to reduced resource consumption, among other advantages.

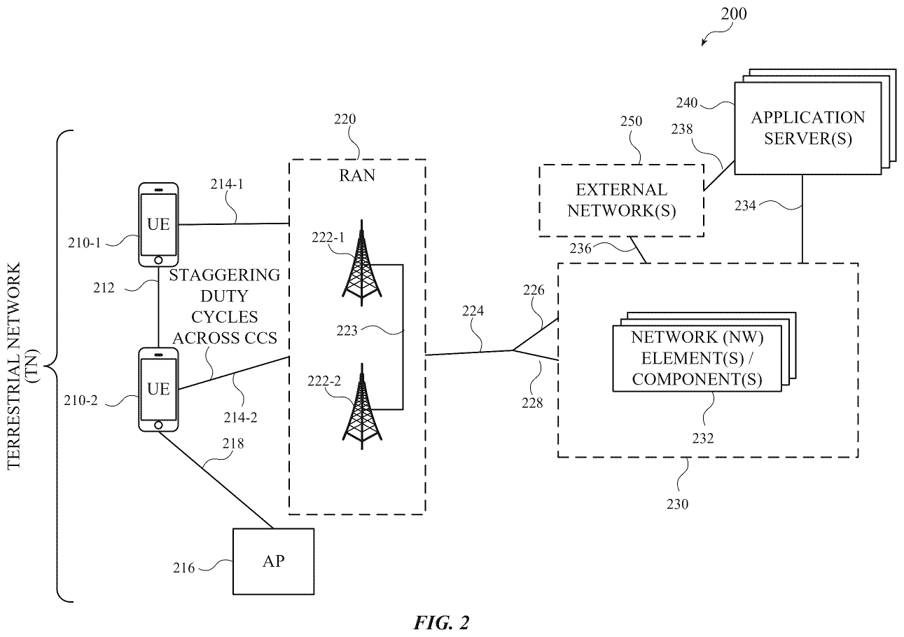

FIG. 2 is an example network 200 according to one or more implementations described herein. Example network 200 can include UEs 210, 210-2, etc. (referred to collectively as “UEs 210” and individually as “UE 210”), RAN 220, core network (CN) 230, application servers 240, and external networks 250.

The systems and devices of example network 200 can operate in accordance with one or more communication standards, such as 3^{rd} generation (3G), 4^{th} generation (4G) (e.g., long-term evolution (LTE)), and/or 5^{th} generation (5G) (e.g., new radio (NR)) communication standards of the 3^{rd} generation partnership project (3GPP). Additionally, or alternatively, one or more of the systems and devices of example network 200 can operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), and more.

As shown, UEs 210 can include smartphones (e.g., handheld touchscreen mobile computing devices connectable to one or more wireless communication networks). Additionally, or alternatively, UEs 210 can include other types of mobile or non-mobile computing devices capable of wireless communications, such as personal data assistants (PDAs), pagers, laptop computers, desktop computers, wireless handsets, etc. In some implementations, UEs 210 can include internet of things (IoT) devices (or IoT UEs) that can comprise a network access layer designed for low-power IoT applications utilizing short-lived UE connections.

Additionally, or alternatively, an IoT UE can utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data can be a machine-initiated exchange, and an IoT network can include interconnecting IoT UEs (which can include uniquely identifiable embedded computing devices within an Internet infrastructure) with short-lived connections. In some scenarios, IoT UEs can execute background applications (e.g., keep-alive messages, status updates, etc.) to facilitate the connections of the IoT network.

UEs 210 can communicate and establish a connection with one or more other UEs 210 via one or more wireless channels 212, each of which can comprise a physical communications interface/layer. The connection can include an M2M connection, MTC connection, D2D connection, SL connection, etc. The connection can involve a PC5 interface. In some implementations, UEs 210 can be configured to discover one another, negotiate wireless resources between one another, and establish connections between one another, without intervention or communications involving RAN node 222 or another type of network node (e.g., base station 120). In some implementations, discovery, authentication, resource negotiation, registration, etc., can involve communications with RAN node 222 or another type of network node.

Various techniques for communication between and among UEs 210 in furtherance of offloading or computing operations are within the scope of the present disclosure. As described herein, in an example, UE 210 can communicate with RAN node 222 to request SL resources. RAN node 222 can respond to the request by providing UE 210 with a dynamic grant (DG) or configured grant (CG) regarding SL resources. UE 210 can communicate with RAN node 222 using a licensed frequency band and communicate with another UE 210 using an unlicensed or licensed frequency band. In another example, UEs 210 can communicate directly without involvement of RAN node 222, such as through resource pools, etc.

UEs 210 can communicate and establish a connection with (e.g., be communicatively coupled) with RAN 220, which can involve one or more wireless channels 214-1 and 214-2, each of which can comprise a physical communications interface/layer. In some implementations, a UE can be configured with dual connectivity (DC) as a multi-radio access technology (multi-RAT) or multi-radio dual connectivity (MR-DC), where a multiple receive and transmit (Rx/Tx) capable UE can use resources provided by different RAN network nodes (e.g., RAN network nodes 222-1 and 222-2) that can be connected via non-ideal backhaul (e.g., where one network node provides NR access and the other network node provides either E-UTRA for LTE or NR access for 5G).

In such a scenario, one network node can operate as a master node (MN) and the other as the secondary node (SN). The MN and SN can be connected via a network interface, and at least the MN can be connected to CN 230. Additionally, at least one of the MN or the SN can be operated with shared spectrum channel access, and functions specified for UE 210 can be used for an integrated access and backhaul mobile termination (IAB-MT). Similar for UE 210, the IAB-MT can access the network using either one network node or using two different nodes with enhanced dual connectivity (EN-DC) architectures, new radio dual connectivity (NR-DC) architectures, or the like. In some implementations, a base station (as described herein) can be an example of network RAN network nodes.

As shown, UE 210 can also, or alternatively, connect to access point (AP) 216 via connection interface 218, which can include an air interface enabling UE 210 to communicatively couple with AP 216. AP 216 can comprise a wireless local area network (WLAN), WLAN node, WLAN termination point, etc. Connection 214 can comprise a local wireless connection, such as a connection consistent with any IEEE 702.11 protocol, and AP 216 can comprise a wireless fidelity (Wi-Fi®) router or other AP. While not explicitly depicted in FIG. 2, AP 216 can be connected to another network (e.g., the Internet) without connecting to RAN 220 or CN 230.

RAN 220 can include one or more RAN nodes 222-1 and 222-2 (referred to collectively as RAN nodes 222, and individually as RAN node 222) that enable channels 214-1 and 214-2 to be established between UEs 210 and RAN 220. RAN node 222 can be a base station and can be referred to herein as base station 222. RAN nodes 222 can include network access points configured to provide radio baseband functions for data and/or voice connectivity between users and the network based on one or more of the communication technologies described herein (e.g., 2G, 3G, 4G, 5G, WiFi®, etc.).

As examples therefore, a RAN node can be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 can include a roadside unit (RSU), a transmission reception point (TRxP or TRP), and one or more other types of ground stations (e.g., terrestrial access points). In some scenarios, RAN node 222 can be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 222, or portions thereof, can be implemented as one or more software entities running on server computers as part of a virtual network, which can be referred to as a centralized RAN (CRAN) and/or a virtual baseband unit pool (vBBUP). In these implementations, the CRAN or vBBUP can implement a RAN function split, such as a packet data convergence protocol (PDCP) split wherein radio resource control (RRC) and PDCP layers can be operated by the CRAN/vBBUP and other Layer 2 (L2) protocol entities can be operated by individual RAN nodes 222; a media access control (MAC)/physical (PHY) layer split wherein RRC, PDCP, radio link control (RLC), and MAC layers can be operated by the CRAN/vBBUP and the PHY layer can be operated by individual RAN nodes 222; or a “lower PHY” split wherein RRC, PDCP, RLC, MAC layers and upper portions of the PHY layer can be operated by the CRAN/vBBUP and lower portions of the PHY layer can be operated by individual RAN nodes 222. This virtualized framework can allow freed-up processor cores of RAN nodes 222 to perform or execute other virtualized applications.

In some implementations, an individual RAN node 222 can represent individual gNB-distributed units (Dus) connected to a gNB-control unit (CU) via individual F1 or other interfaces. In such implementations, the gNB-Dus can include one or more remote radio heads or radio frequency (RF) front end modules (RFEMs), and the gNB-CU can be operated by a server (not shown) located in RAN 220 or by a server pool (e.g., a group of servers configured to share resources) in a similar manner as the CRAN/vBBUP. Additionally, or alternatively, one or more of RAN nodes 222 can be next generation eNBs (i.e., gNBs) that can provide evolved universal terrestrial radio access (E-UTRA) user plane and control plane protocol terminations toward UEs 210, and that can be connected to a 5G core network (5GC) 230 via an NG interface.

Any of RAN nodes 222 can terminate an air interface protocol and can be the first point of contact for UEs 210. In some implementations, any of RAN nodes 222 can fulfill various logical functions for RAN 220 including, but not limited to, radio network controller (RNC) functions such as radio bearer management, uplink and downlink dynamic radio resource management and data packet scheduling, and mobility management. UEs 210 can be configured to communicate using orthogonal frequency-division multiplexing (OFDM) communication signals with each other or with any of RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals can comprise a plurality of orthogonal subcarriers.

The PDSCH can carry user data and higher layer signaling to UEs 210. The physical downlink control channel (PDCCH) can carry information about the transport format and resource allocations related to the PDSCH, among other things. The PDCCH can also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) can be performed at any of RAN nodes 222 based on channel quality information fed back from any of UEs 210. The downlink resource assignment information can be sent on the PDCCH used for (e.g., assigned to) each of UEs 210.

One or more of the techniques, described herein, can enable UE 210 to leverage transmissions along an individual CC associated with a CC group (e.g., a CC group for SSB, a CC group for CSI-RS). For example, UE 210 can be configured to receive SSBs or CSI-RSs via a single CC of a respective CC group. For example, UE 210 can receive a CSI-RS from RAN node 222-1 via a single CC of a CC group for CSI-RS implemented by RAN node 222-1 and RAN node 222-2, and UE 210 can use the CSI-RS for performing measurements associated with determining mobility information for the CC group for CSI-RS. By enabling UE 210 to receive a CSI-RS from a single CC of the CC group for CSI-RS rather than from each CC of the CC group for CSI-RS, the network can experience improved NES due to reduced resource consumption, among other advantages. These and many other features and aspects of the techniques described herein are presented below with reference to remaining Figures.

RAN nodes 222 can be configured to communicate with one another via interface 223. In implementations where the system is an LTE system, interface 223 can be an X2 interface. In NR systems, interface 223 can be an Xn interface. The X2 interface can be defined between two or more RAN nodes 222 (e.g., two or more eNBs/gNBs or a combination thereof) that connect to evolved packet core (EPC) or CN 230, or between two eNBs connecting to an EPC. RAN nodes 222 can be configured to communicate with CN 230 via various interfaces, such as physical interfaces, including interface 224, interface 226, and interface 228.

In some implementations, the X2 interface can include an X2 user plane interface (X2-U) and an X2 control plane interface (X2-C). The X2-U can provide flow control mechanisms for user data packets transferred over the X2 interface and can be used to communicate information about the delivery of user data between eNBs or gNBs. For example, the X2-U can provide specific sequence number information for user data transferred from a master eNB (MeNB) to a secondary eNB (SeNB); information about successful in sequence delivery of PDCP packet data units (PDUs) to UE 210 from an SeNB for user data; information of PDCP PDUs that were not delivered to UE 210; information about a current minimum desired buffer size at the SeNB for transmitting to the UE user data; and the like. The X2-C can provide intra-LTE access mobility functionality (e.g., including context transfers from source to target eNBs, user plane transport control, etc.), load management functionality, and inter-cell interference coordination functionality.

As shown, RAN 220 can be connected (e.g., communicatively coupled) to CN 230. CN 230 can comprise a plurality of network elements 232, which are configured to offer various data and telecommunications services to customers/subscribers (e.g., users of UEs 210) who are connected to CN 230 via RAN 220. In some implementations, CN 230 can include an evolved packet core (EPC), a 5G CN, and/or one or more additional or alternative types of CNs. The components of CN 230 can be implemented in one physical node or separate physical nodes including components to read and execute instructions from a machine-readable or computer-readable medium (e.g., a non-transitory machine-readable storage medium).

In some implementations, network function virtualization (NFV) can be utilized to virtualize any or all the above-described network node roles or functions via executable instructions stored in one or more computer-readable storage mediums (described in further detail below). A logical instantiation of CN 230 can be referred to as a network slice, and a logical instantiation of a portion of CN 230 can be referred to as a network sub-slice. Network Function Virtualization (NFV) architectures and infrastructures can be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

As shown, CN 230, application servers 240, and external networks 250 can be connected to one another via interfaces 234, 236, and 238, which can include IP network interfaces. Application servers 240 can include one or more server devices or network elements (e.g., virtual network functions (VNFs) offering applications that use IP bearer resources with CN 230 (e.g., universal mobile telecommunications system packet services (UMTS PS) domain, LTE PS data services, etc.). Application servers 240 can also, or alternatively, be configured to support one or more communication services (e.g., voice over IP (VOIP) sessions, push-to-talk (PTT) sessions, group communication sessions, social networking services, etc.) for UEs 210 via CN 230. Similarly, external networks 250 can include one or more of a variety of networks, including the Internet, thereby providing the mobile communication network and UEs 210 of the network access to a variety of additional services, information, interconnectivity, and other network features.

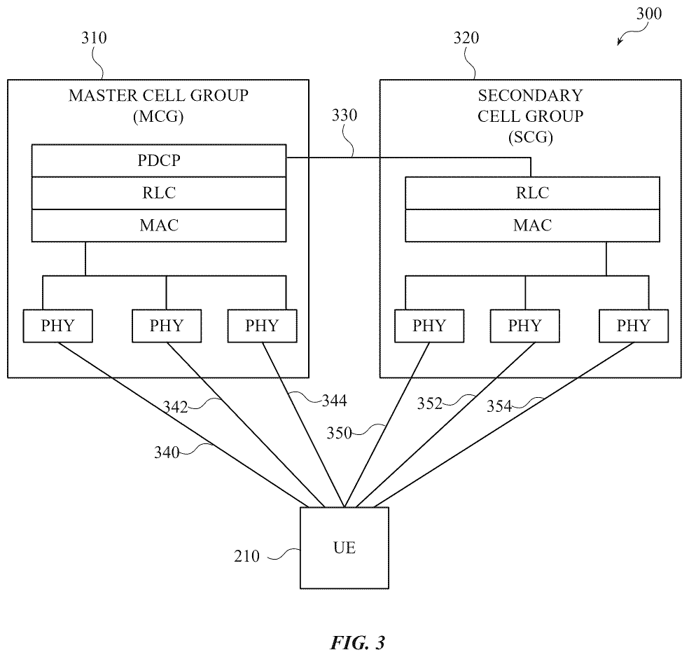

FIG. 3 is a diagram of an example 300 of master cell group (MCG) 310 and secondary cell group (SCG) 320 according to one or more implementations described herein. An MCG can include a group of cells associated with a master node, comprising a primary cell (PCell) and one or more secondary cells (SCell). An SCG can include a group of serving cells associated with a secondary node, comprising a PCell of a secondary cell group and optionally one or more SCells. MCG 310 and SCG 320 can each be implemented by one or more base stations 222 and/or another type of RAN node 222 or network access point.

MCG 310 can be implemented by one or more RAN nodes 222 and can include one or more layers. Examples of such layers can include a PDCP layer, an RLC layer, a MAC layer, and multiple PHY layers. Each PHY layer can correspond to a different implementation of a cell with respect to UE 210. Additionally, or alternatively, the PHY layers can operate in combination (e.g., be managed, controlled by, etc.) the PDCP, RLC, and MAC layers. In some implementations, one PHY layer 340 can operate as a PCell or a special cell (SpCell) and other PHY layers 342 and 344 can operate as SCells to the PCell.

SCG 320 can include multiple layers as well, including an RLC layer, a MAC layer, and multiple PHY layers 350, 352, and 354. SCG 320 may not include a PDCP layer, but instead can rely on the PDCP layer of MCG 310 via connection 330. Similar to the PHY layers of MCG 310, the PHY layers of SCG 320 can each function or operate as a cell with respect to UE 210. In some implementations, one PHY layer 350 can operate as a PCell to PHY layers 352 and 354, which can operate as SCells to the PCell of PHY layer 350. Additionally, MCG 310 and SCG 320 can each include a PCell (e.g., 340 and 350), and a PCell can be referred to herein as a special cell or special primary cell, represented as SpCell. Further, an SCell, of either MCG 310 or SCG 320, can operate as a scheduling secondary cell (sSCell) configured to provide configuration, scheduling, activation, deactivation, and other functions or commands toward a SpCell of either MCG 310 or SCG 320.

MCG 310 and SCG 320 can be involved in a dual connectivity scenario with UE 210, in which case a random access channel (RACH) procedure, and the like, can be directed to MCG 310. MCG 310 and SCG 320 can also implement a standalone (SA) and/or a non-standalone (NSA) network environment for UE 210. In a SA network environment, MCG 310 and SCG 320 can communicate with UE 210 using 5G NR communication standards, 6G communications standards, 7G communication standards, and more.

In an NSA network environment, MCG 310 and SCG 320 can communicate with UE 210 using a combination of, for example, 4G LTE, 5G NR, and 6G communication standards. In some implementations another combination can be used. Carrier aggregation (CA) can include a scenario in which UE 210 aggregates component carriers from a PCell under MCG 310 and an SCell under MCG 310. Dual connectivity can include, for example, a scenario in which UE 210 connects to cells under MCG 310 and SCG 320. Carrier aggregation (CA) can include, for example, a scenario in which UE 210 aggregates CCs from a PCell under MCG 310 and an SCell under MCG 310. Dual connectivity can include, for example, a scenario in which UE 210 connects to cells under MCG 310 and SCG 320.

One or more of the techniques described herein can enable duty cycles for SSBs and/or CSI-RSs to be staggered across CCs of a CC group (e.g., a CC group for SSB, a CC group for CSI-RS). For example, UE 210 can receive SSBs and/or CSI-RSs from base station 222. The SSBs and/or CSI-RSs can be staggered across the CCs of a respective CC group (e.g., a CC group for SSB, a CC group for CSI-RS), according to a staggering schedule. Doing so can enable or otherwise help support the implementation of NES within the network. Base station 222 can be configured to operate as one or more types of cell groups (e.g., MCG 310, SCG 320, etc.) and/or types of cells (e.g., PCell, SCell, PSCell, sSCell, etc.). In some implementations, base station 222 can operate cooperatively or in tandem with one or more other base stations 222, which can also be configured to operate as one or more types of cell groups and/or cells.

The CCs of a CC group (e.g., a CC group for SSB, a CC group for CSI-RS) can be staggered, with respect to one another, according to a staggering schedule that can be referred to as a transmission schedule, reception schedule, or another type of sequence, pattern, or relativistic framework. A staggering schedule can include one or more types of time domain characteristics, such as a periodicity, offset, time delay, timer, reset timer, time gap, measurement gap, timing window, etc. Different staggering schedules can have the same, different, different combination, and/or a different number of time domain characteristics. Additionally, or alternatively, the values of a particular type of characteristic, within a particular staggering schedule or between different staggering schedules, can vary. For example, the value of an offset associated with one instance of an CSI-RS can be different than an offset associated with another instance of an CSI-RS of the same CC or CC group for CSI-RS. Different staggering schedules can be associated with different types of information.

For example, UE 210 and base station 222 can use a first staggering schedule for synchronization signal blocks (SSBs), a second staggering schedule for CSI-RS transmissions, and a third staggering schedule for CQI transmissions. In some implementations, a staggering schedule can be used for more than one type of signal and/or information. For example, a first staggering schedule can be used for SSBs, while a second staggering schedule can be used for both CSI-RS transmissions and CQI transmissions.

In such a scenario, UE 210 and/or base station can determine time and frequency resources for one type of transmission based on another type of transmission. For example, the staggering schedule can provide explicit transmission times for CSI-RS transmissions and the transmission times for CQI transmissions can be inferred or determined based on the transmission times of the CSI-RS transmissions (e.g., a CQI can be transmitted upon expiration of a specified duration measured from the most recent CSI-RS transmission). Frequency resources can also, or alternatively, be determined relative to the frequency resources of another type of transmission (e.g., the CC for transmitting a CQI can be determined to be a next, current, or most recent CC relative to the CC used for a next, current, or most recent CSI-RS transmission

The staggering schedule can indicate time domain and/or frequency domain resources allocated for the transmission and/or reception of one or more types of signals or information, and/or performance of one or more types of operations. For example, a staggering schedule can indicate time domain resources associated with the transmission and/or reception of a reference signal (e.g., a CSI-RS). As another example a staggering schedule can also, or alternatively, indicate frequency domain resources associated with the transmission and/or reception of one or more types of signals or information. Examples of the frequency domain resources can include one or more carriers, CCs, channels, subchannels, bandwidths, bandwidth parts (BWPs), and/or one or more other types of frequency domain resources. Additional features and examples of staggering schedules are described with reference to the remaining Figures.

Implementing the staggering schedule can support NES by increasing a periodicity for transmitting SSBs and/or CSI-RSs over each CC of the CC group for SSB or the CC group for CSI-RS. By increasing the periodicity, the SSBs and/or CSI-RSs can be transmitted on each CC relatively less frequently, thereby conserving resource allocation and consumption otherwise associated with transmitting the SSBs and/or the CSI-RSs via the respective CC. Implementing resource conservation at each CC of the respective CC group (e.g., the CC group for SSB, the CC group for CSI-RS) can support resource conservation broadly across a network, thus increasing NES.

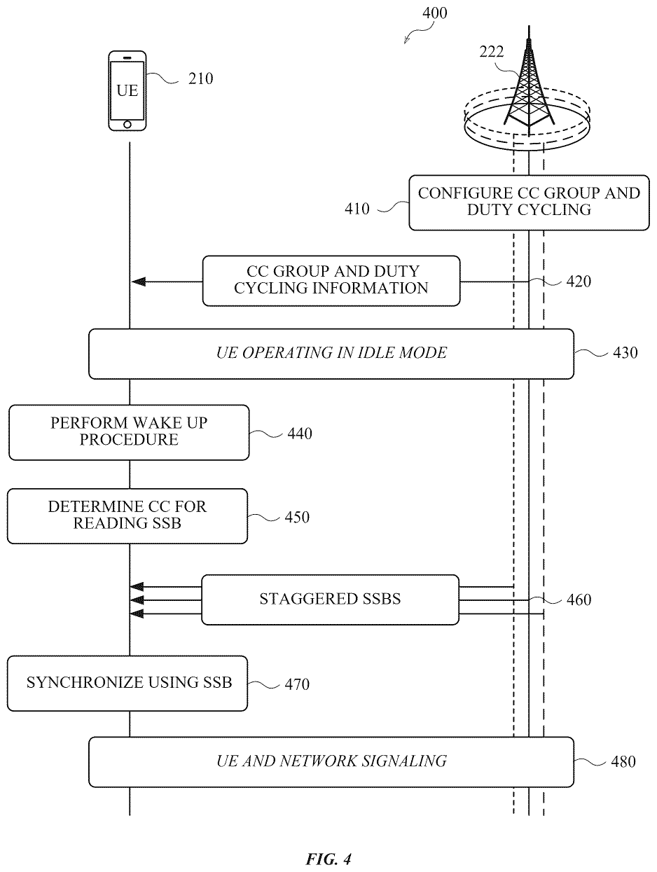

FIG. 4 is a diagram of an example process 400 for staggering an SSB duty cycle across CCs of a CC group for SSB according to one or more implementations described herein. As shown, process 400 can be performed by UE 210 and base station 222. Operations described as being performed by UE 210 can be performed, at least in part, by baseband circuitry of UE 210. Base station 222 can be implemented by base station 120 or another type of network access point. In some scenarios, base station 222 can be representative of the network facilitating operations of base station 222. Some or all of process 400 can be performed by one or more other systems or devices, including one or more of the devices of FIG. 1 or FIG. 2. Additionally, process 400 can include one or more fewer, additional, differently ordered, and/or arranged operations than those shown in FIG. 4. Some or all of the operations of process 400 can be performed independently, successively, simultaneously, etc., of one or more of the other operations of process 400. As such, the techniques described herein are not limited to the number, sequence, arrangement, timing, etc., of the operations or processes depicted in FIG. 4. The duty cycling across the CCs can account for the beam structure of the cell as omni or sectorized. The duty cycling for sectorized individual UEs 210 can selectively use each CC indicated by the network to be part of the CC group for SSB or can use a subset of the CCs for system camping and operations.

As shown, process 400 can include configuring the CCs associated with the cells of base station 222 (e.g., and other cells associated with other base stations) to operate in a collaborative manner which can support CC groups for SSB (block 410). For example, the network can configure cells of base station 222 to support a CC group for SSB including CCs associated with the cells. In some such examples, the network can define the CC group as a CC-GroupForSSB including multiple CCs. In some scenarios, the network can define the CC group for SSB for the individual UE 210 (e.g., based on identifying that UE 210 is operating in an idle mode). Process 400 can also include configuring a duty cycle supported by the CC group for SSB (block 410). For example, the network can configure a staggering schedule for communicating SSBs via the CCs of the CC group for SSB. That is, the network can identify a periodicity for communicating SSBs on each CC of the CC group for SSB, such that the periodicity associated with each CC group for SSB is offset in time to facilitate communicating SSBs according to a duty cycle provided by the CC group for SSB (e.g., based on each CC of the CC group for SSB).

As shown, process 400 can include communicating an indication of the CC group for SSB and duty cycling information associated with the CC group for SSB (block 420). For example, base station 222 can transmit signaling to UE 210 indicating the CC group for SSB and the duty cycling of SSBs associated with the CC group for SSB. In some such examples, the signaling can identify the CC group for SSB such that UE 210 can determine which CCs to monitor for the SSBs. Likewise, the signaling can identify the staggering schedule for receiving the SSBs from base station 222 via the CCs of the CC group for SSB. For example, the signaling can indicate that a first SSB is transmitted from base station 222 on a first CC of the CC group for SSB at a first time, a second SSB is transmitted from base station 222 on a second CC of the CC group for SSB at a second time (e.g., after the first time, separated from the first time by a duration), and a third SSB is transmitted from base station 222 on a third CC of the CC group for SSB (e.g., before a fourth SSB is transmitted on the first CC). In some scenarios, the indication of the CC group for SSB and the duty cycling information can be provided to UE 210 using a system information block (SIB). For example, the duty cycling information can be captured as a parameter defined as ssb-ToMeasure and can be included in SIB2 and SIB4 for intra-frequency and inter-frequency neighbors.

In other scenarios (e.g., not shown in FIG. 4), process 400 can alternatively include UE 210 autonomously learning the CC group for SSB and the duty cycling information associated with the CC group for SSB. For example, UE 210 can monitor SSBs transmitted across different CCs associated with base station 222 (e.g., and other cells associated with other base stations) and determine the CC group for SSB based on monitoring the SSBs. In some such examples, UE 210 can detect a periodicity of SSBs communicated via a CC is different from a given rate (e.g., an expected rate), and determine to scan other CCs associated with base station 222 to identify the periodicity of SSBs communicated via the other CCs. UE 210 can determine a CC grouping function implemented by the network and identify the CCs of the CC group for SSB. In some examples, UE 210 can use the identification of the CC group for SSB to derive the duty cycling parameters for monitoring the SSBs communicated across the CCs of the CC group for SSB.

As shown, process 400 can include UE 210 operating in an idle mode (block 430). For example, UE 210 can be configured to enter into an idle mode (e.g., inactive mode, low power mode) based on inactivity. That is, UE 210 can be camped (e.g., idle) on a given CC (e.g., CC 130) or within the coverage area of one or more cells (e.g., including a PCell, a PSCell, an SCell, a neighboring cell) associated with base station 222. In some such examples, UE 210 can identify mobility state information associated with UE 210 to determine a mobility state of UE 210. UE 210 can identify that UE 210 is in an idle (e.g., stationary) mobility state (e.g., or a mobile) based on performing an idle mode mobility function based on the mobility state information. In some scenarios, UE 210 can transmit an indication to base station 222 identifying that UE 210 is operating in an idle mode. In some such scenarios, the network can configure subsequent operations based on determining UE 210 is operating in the idle mode.

As shown, process 400 can include performing a wake up procedure for UE 210 (block 440). UE 210 can use the indication of the CC group for SSB and the duty cycling information received from base station 222, or the determination of the CC group for SSB and the duty cycling parameters identified by UE 210 to determine a wake up procedure for UE 210. Performing the wake up procedure can involve transitioning from the idle mode to an active mode (e.g., high power mode) and subsequently reading the SSBs received from the different CCs of the CC group for SSB. For example, UE 210 can wake up and begin detecting SSBs, where upon identifying a relatively most recent SSB (e.g., an SSB received closest in time to the paging occasion) communicated via the CC group for SSB, UE 210 can read the SSB. In some examples, UE 210 can wake up based on being assigned a paging occasion from the network or based on detecting wake up parameters. UE 210 can read the SSB based on recency rather than the CC that UE 210 can be camped on, such that UE 210 can read the SSB from a different CC than UE 210 is camped on within the CC group for SSB.

As shown, process 400 can include determining a CC of the CC group for SSB for reading the SSBs (block 450). For example, UE 210 can select a CC of the CC group for SSB upon which SSBs are being communicated from base station 222, and UE 210 can read the SSBs received via the selected CC. In some such examples, UE 210 can select the CC from the CC group for SSB based on identifying signal strengths associated with each CC of the CC group for SSB and selecting the CC based on the signal strength (e.g., a relatively strongest signal). Likewise, UE 210 can ignore CCs from the CC group for SSB with relatively weaker signal strength, which can be based on the one or more cells associated with the weaker CCs. In some implementations (e.g., a cell edge scenario), UE 210 can measure vertical neighboring CCs using the ssb-ToMeasure information and an expected location of the SSB transmitted from the vertical neighboring CCs including the duty cycling of SSBs in the individual CCs. Thus, selecting the CC based on signal strength can account for non-collocated scenarios or scenarios in which there is a low overlap of cells for duty cycling the SSBs. In some scenarios, UE 210 can transmit a report to the network (e.g., to base station 222) requesting the network to take corrective action, such as reconfiguring the CC group for SSB to include other CCs. For example, the report can indicate the network to remove specific CCs associated with weaker signal strength or associated with non-collocated cells from the CC group for SSB.

In some scenarios, UE 210 can implement independent crystal oscillators for the individual CCs of the CC group for SSB based on the frequency bands of operations associated with the CC group for SSB. In other scenarios, UE 210 can implement multiple crystal oscillators that can be synchronized for transport overhead and/or frame overhead, or the synchronization can be transferred between crystal oscillators within UE 210. UE 210 can select the CCs for monitoring the SSBs to maintain transport over and/or frame overhead synchronization when camped on a CC in the idle mode.

As shown, process 400 can include communicating the SSBs via the CC group for SSB according to a staggering schedule (block 460). For example, the SSBs can be communicated in multiple staggering series over each CC of the CC group for SSB from base station 222 to UE 210. That is, each CC of the CC group for SSB can transmit a series of SSBs such that the SSBs are received at UE 210 in a time order varying across the CC group for SSB. In some scenarios, UE 210 can use the CC selected from the CC group for SSB (at block 425) as a designated CC for receiving the SSBs. In some scenarios, UE 210 can implement interference canceling to prevent interference associated with receiving the staggering SSBs across the CC group for SSB. For example, UE 210 can implement interference canceling for horizontal neighboring cells. In some examples, the interference canceling can be based on the PDSCH received in a cell associated with UE 210. In some implementations, base station 222 can indicate UE 210 to perform interference canceling and can specify parameters associated with performing the interference canceling such as interference targets.

As shown, process 400 can include performing synchronization using the SSBs received at UE 210 (block 470). That is, UE 210 can synchronize with one or more cells of base station 222 using information included within the SSBs transmitted from base station 222. Performing synchronization can synchronize operations of UE 210 with operations of base station 222. In some examples, UE 210 can read the SSBs and perform transport overhead and/or frame overhead syncing based on the SSBs. In some such examples, UE 210 can read the SSBs from a CC of the CC group for SSB other than a CC that UE 210 is camped on to perform the transport overhead and/or frame overhead syncing. After synchronizing UE 210 with base station 222, UE 210 can be configured to communicate signaling with the network (e.g., base station 222) (block 480). For example, UE 210 can communicate other signaling with the network based on establishing and maintaining a connection with the network.

In some scenarios, based on performing process 400, UE 210 can determine a CC or cell to camp on. For example, UE 210 can determine a cell is valid based on the determination performed at block 425. That is, UE 210 can make a camping decision regarding the cell based on determining the cell is valid, which can be identified based on SSBs measured from the cell. In some implementations, determining to camp on a cell can involve a relatively longer duration (e.g., latency impact) based on reduced SSB transmissions from a cell given the staggering of the SSB transmissions, yet the latency impact can be relatively minimal to UE 210. In some scenarios, UE 210 can designate a CC of the CC group for SSB as the camped frequency for idle mode operations and retain procedures for entering a cell and idle mobility behaviors.

In some examples, UE 210 can enter a non-stationary (e.g., mobile) mode in which UE 210 can begin moving between coverage areas associated with cells of the network. In some such examples, UE 210 can recognize changes in signal strength (e.g., reference signal received power (RSRP)) values of the CCs from the CC group for SSB to determine that UE 210 has entered the non-stationary mode. In other examples, UE 210 can use motion detection sensors or an internal global positioning system to determine that UE 210 has entered the non-stationary mode. In some scenarios, based on entering the non-stationary mode, UE 210 can be triggered to remain active for reading the SSBs received from the CC group for SSB (e.g., specifically the camped CC). In some such scenarios, UE 210 can perform a handoff (e.g., in accordance with the network) from the camped CC based on an SIB received via the camped CC.

In some scenarios, based on performing process 400, UE 210 can perform a link maintenance procedure. That is, after performing synchronization using the SSBs received at UE 210 (block 435), UE 210 can perform a link maintenance procedure in which UE 210 evaluates and maintains the connection between UE 210 and base station 222 across one or more CCs of the CC group for SSB. For example, UE 210 can perform link maintenance for the CC group for SSB based on evaluating the connection with a CC of the CC group for SSB. In some implementations, base station 222 can provide (e.g., as part of ssb-ToMeasure) UE 210 with an indication for which cells (e.g., PSCells, SCells) and/or CCs of the CC group for SSB to perform link maintenance. In some scenarios, UE 210 can use the SSB from an individual CC of the CC group for SSB to maintain the connection, and UE 210 can perform link maintenance for the CC group for SSB based on the SSB from the individual CC. In some such scenarios, UE 210 can determine a connectivity failure associated with the individual CC (e.g., or another CC of the CC group for SSB), where UE 210 is unable to maintain the connection using the individual CC. However, UE 210 can maintain the connection using the other CCs of the CC group for SSB based on leveraging the SSB from the individual CC. UE 210 can transmit an indication of the connectivity failure to base station 222 based on the connection being maintained using the other CCs of the CC group for SSB. In some examples, similar techniques can be implemented for connectivity failures of a cell. For example, UE 210 can request (e.g., or be proactively provided by the network) swapping cells (e.g., from a PCell to an SCell) based on determining a connectivity failure associated with a cell, but maintaining connection with other cells associated with the CC group for SSB based on leveraging the SSB from the individual CC associated with the cell.

Process 400 can support leveraging SSBs communicated via individual CCs of the CC group for SSB based on implementing the staggering schedule for communicating SSBs across the CC group for SSB. Staggering the SSBs communicated across the CC group for SSB can provide durations (e.g., time gaps, slots) in the individual CCs that can be used for communicating other signaling such as PDSCH. Alternatively, staggering the SSBs can provide durations that reduce resource utilization by the network, which can support NES.

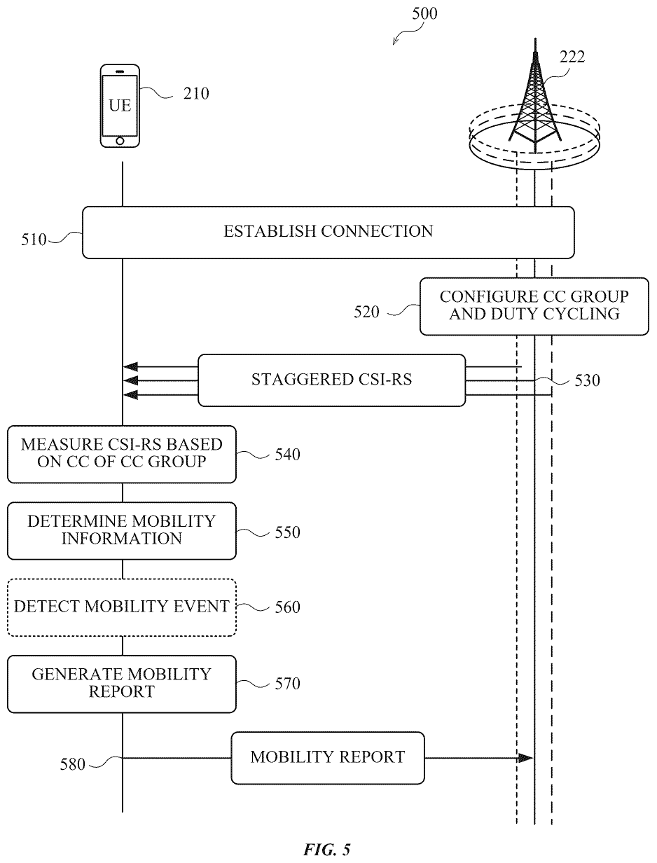

FIG. 5 is a diagram of an example process 500 for staggering a CSI-RS duty cycle across CCs of a CC group for CSI-RS according to one or more implementations described herein. As shown, process 500 can be performed by UE 210 and base station 222. Operations described as being performed by UE 210 can be performed, at least in part, by baseband circuitry of UE 210. base station 222 can be implemented by base station 120 or another type of network access point. In some scenarios, base station 222 can be representative of the network facilitating operations of base station 222. Some or all of process 500 can be performed by one or more other systems or devices, including one or more of the devices of FIG. 1 and FIG. 2. Additionally, process 500 can include one or more fewer, additional, differently ordered, and/or arranged operations than those shown in FIG. 5. Some or all of the operations of process 500 can be performed independently, successively, simultaneously, etc., of one or more of the other operations of process 500. As such, the techniques described herein are not limited to the number, sequence, arrangement, timing, etc., of the operations or processes depicted in FIG. 5.

As shown, process 500 can include establishing a connection between UE 210 and base station 222 (block 510). Establishing the connection can include operations as shown in process 400 as described with reference to FIG. 4. For example, establishing the connection between UE 210 and base station 222 can include configuring, at base station 222 (e.g., by the network), a CC group for SSB (e.g., a CC-GroupForSSB) for communicating SSBs to UE 210 and a duty cycle for communicating the SSBs via the individual CCs of the CC group for SSB. Likewise, establishing the connection can include communicating the SSBs to UE 210 via individual CCs of the CC group for SSB according to the duty cycle (e.g., periodicities associated with each CC) and using the SSBs to perform a synchronization operation associated with synchronizing UE 210 and base station 222.

Process 500 can also include identifying that UE 210 is operating in a connected mode. That is, UE 210 can be camped on a CC (e.g., CC 130) or within the coverage area of one or more cells (e.g., including a PCell, a PSCell, an SCell, a neighboring cell) associated with base station 222. The connected mode can involve UE 210 being in an active mode or a non-stationary mode, such that UE 210 can be camped on a CC or a cell, yet configured to move between the cell and a neighboring cell. In some examples, UE 210 can identify mobility state information associated with UE 210 to determine a mobility state of UE 210. UE 210 can identify that UE 210 is in the connected mode based on performing an idle mode mobility function based on the mobility state information. In some scenarios, UE 210 can transmit an indication to base station 222 identifying that UE 210 is operating in the connected mode. In some such scenarios, the network can configure subsequent operations based on determining UE 210 is operating in the connected mode.

As shown, process 500 can include configuring the CCs associated with the cells of base station 222 (e.g., and other cells associated with other base stations) to operate in a collaborative manner which support CC groups for CSI-RS (block 520). For example, the network can configure cells of base station 222 to support a CC group for CSI-RS including CCs associated with the cells. In some such examples, the network can define the CC group for CSI-RS as a CC-GroupForCSI-RS including multiple CCs. The CC group for CSI-RS (e.g., the CC-GroupForCSI-RS) described in process 500 can be different from the CC group for SSB (e.g., the CC-GroupForSSB) described in process 300. In some scenarios, the network can define the CC group for CSI-RS for individual UE 210. For example, the network can define the CC group for CSI-RS based on identifying that UE 210 is operating in the connected mode. Process 500 can also include configuring a duty cycle supported by the CC group for CSI-RS (block 520). For example, the network can configure a staggering schedule for communicating CSI-RSs via the CCs of the CC group for CSI-RS. That is, the network can identify a periodicity for communicating CSI-RSs on each CC of the CC group for CSI-RS, such that the periodicity associated with each CC group for CSI-RS is offset in time to facilitate communicating CSI-RSs according to a duty cycle provided by the CC group for CSI-RS (e.g., based on each CC of the CC group for CSI-RS).

In some scenarios, base station 222 can be configured to communicate an indication of the CC group for CSI-RS and duty cycling information associated with the CC group for CSI-RS to UE 210. For example, base station 222 can transmit signaling identifying the CC group for CSI-RS such that UE 210 can determine which CCs to monitor for the CSI-RSs. Likewise, the signaling can indicate the staggering schedule for receiving the CSI-RSs from base station 222 via the CCs of the CC group for CSI-RS. In some such scenarios, the indication of the CC group for CSI-RS and the duty cycling information can be provided to UE 210 using a system information block (SIB). In other scenarios, UE 210 can autonomously learn the CC group for CSI-RS and the duty cycling information associated with the CC group for CSI-RS. For example, UE 210 can monitor CSI-RSs transmitted across different CCs associated with base station 222 (e.g., and other cells associated with other base stations) and determine the CC group for CSI-RS based on monitoring the CSI-RSs. In some such examples, UE 210 can detect a periodicity of CSI-RSs communicated via a CC is different from a given rate (e.g., an expected rate), and determine to scan other CCs associated with base station 222 to identify the periodicity of CSI-RSs communicated via the other CCs. In some examples, UE 210 can use the identification of the CC group for CSI-RS to derive the duty cycling parameters for monitoring the CSI-RSs communicated across the CCs of the CC group for CSI-RS. In other scenarios, UE 210 can determine the CC group for CSI-RS based on the SSBs transmitted or the CC group for SSB (e.g., CC-GroupForSSB) identified as part of process 400.

As shown, process 500 can include communicating the CSI-RSs via the CC group for CSI-RS according to a staggering schedule (block 530). The CSI-RSs can be communicated in multiple staggering series over each CC of the CC group for CSI-RS from base station 222 to UE 210. That is, each CC of the CC group for CSI-RS can transmit a series of CSI-RSs such that the CSI-RSs are received at UE 210 in a time order varying across the CC group for CSI-RS. For example, communicating the CSI-RSs via the CC group for CSI-RS can include transmitting a first CSI-RS from base station 222 on a first CC of the CC group for CSI-RS at a first time, transmitting a second CSI-RS from base station 222 on a second CC of the CC group for CSI-RS at a second time (e.g., after the first time, separated from the first time by a duration), and transmitting a third CSI-RS from base station 222 on a third CC of the CC group for CSI-RS before transmitting a fourth CSI-RS from base station 222 on the first CC.

As shown, process 500 can include measuring the CSI-RSs based on CC of the CC group for CSI-RS (block 540). That is, process 500 can include performing mobility measurements on the CC group for CSI-RS based on the CSI-RSs. For example, UE 210 can receive the CSI-RSs from the CC group for CSI-RS according to the staggering schedule and use a CSI-RS from an individual CC of the CC group for CSI-RS to perform mobility measurements. In some implementations, UE 210 can use the CSI-RS to perform mobility measurements for a CC of the CC group for CSI-RS, or UE 210 can use the CSI-RS to perform mobility measurements for each CC of the CC group for CSI-RS. In some scenarios, UE 210 can use the CSI-RS received most recently to perform the mobility measurements.

In some scenarios, performing the mobility measurements can include identifying signal parameters associated with one or more CCs of the CC group for CSI-RS based on the CSI-RS, which can include identifying reference signal received power (RSRP), reference signal received quality (RSRQ), and signal interference noise ratio (SINR) of the one or more CCs of the CC group for CSI-RS. In some such scenarios, the mobility measurements can be performed on horizontal and vertical frequency neighbors of the one or more CCs of the CC group for CSI-RS based on using the CSI-RS associated with the CC group for CSI-RS. In some scenarios, the mobility measurements can be performed on one or more cells associated with base station 222 and/or one or more cells associated with another base station 222. For example, UE 210 can perform mobility measurements on a PCell, a PSCell, an SCell, or a neighboring cell associated with one or more CCs of the CC group for CSI-RS. In another example, UE 210 can perform mobility measurements on horizontal and vertical neighboring cells associated with the CC group for CSI-RS. UE 210 can perform the mobility measurements on various cells to determine mobility information associated with performing a handoff from the PCell (e.g., or the PSCell) to another cell (e.g., an SCell, a neighboring cell).

In some scenarios, base station 222 (e.g., the network) can indicate to UE 210 which CCs and/or cells to measure. For example, base station 222 can provide a list of neighbors (e.g., neighboring CCs of the CC group for CSI-RS, neighboring cells) to UE 210 to measure for determining mobility information. In other scenarios, UE 210 can determine which CCs and/or cells to measure. For example, UE 210 can identify a CC of the CC group for CSI-RS and base station 222 can provide the list of neighboring CCs to measure based on the identified CC. Additionally, or alternatively, UE 210 can identify a cell (e.g., the PCell) and base station 222 can provide the list of neighboring cells to measure based on the identified cell.

In some scenarios, the mobility measurements can be performed for an individual CC of the CC group for CSI-RS, a subset of CCs of the CC group for CSI-RS, or averaged across the CC group for CSI-RS (e.g., or a subset of the CC group for CSI-RS). For example, the mobility measurements associated with an individual CC of the CC group for CSI-RS can be identified as representative of each CC of the CC group for CSI-RS, and therefore used for determining mobility information. In another example, the mobility measurements associated with a subset of CCs of the CC group for CSI-RS can be identified as representative of the CC group for CSI-RS, and therefore used for determining mobility information.

In some examples, the mobility measurements averaged across the CC group for CSI-RS can be used for determining mobility information. In some such examples, the mobility measurements can be averaged across the CC group for CSI-RS before the mobility information can be determined. In some implementations, base station 222 (e.g., the network) can indicate to UE 210 whether to average the mobility measurements across the CC group for CSI-RS. That is, base station 222 can include such an indication in a CSI configuration using RRC signaling, in a downlink control channel, or MAC control element (MAC-CE) signaling. Additionally, or alternatively, the indication to average the mobility measurements across the CC group for CSI-RS can be specified in parameters (e.g., nrofSS-BlocksToAverage, nrofCSI-RS-ResourcesToAverage) in an information element (e.g., MeasObjectNR information element). In other implementations, UE 210 can indicate to base station 222 whether UE 210 is capable of averaging the mobility measurements across the CC group for CSI-RS. That is, UE 210 can include such an indication in UE capability signaling.

As shown, process 500 can include determining mobility information (block 550). UE 210 can determine the mobility information based on performing the mobility measurements on one or more CCs and/or one or more cells. In some scenarios, the mobility information can include signal parameters associated with one or more CCs of the CC group for CSI-RS, such as RSRP, RSRQ, SINR, hysteresis, offset, and cell specific offset of the one or more CCs of the CC group for CSI-RS. In some implementations, the mobility information can be indicative of horizontal and vertical frequency neighbors of the one or more CCs of the CC group for CSI-RS. In some implementations, the mobility information can be indicative of a PCell, a PSCell, an SCell, or a neighboring cell associated with UE 210. For example, UE 210 can determine the mobility information for horizontal or vertical neighboring cells associated with the one or more cells with which UE 210 is associated.

As shown, process 500 can include detecting a mobility event (block 560). UE 210 can detect a mobility event based on the mobility information associated with one or more CCs and/or one or more cells. In some scenarios, detecting a mobility event can include comparing the mobility information with one or more thresholds to determine whether the mobility information satisfies the one or more thresholds. Determining whether the mobility information satisfies the one or more thresholds can include determining whether a value associated with the mobility information is greater than (e.g., or equal to) a threshold, less than (e.g., or equal to) a threshold, or within a range defined by two thresholds (e.g., between a first threshold and a second threshold, including or excluding each threshold). In some such scenarios, determining that the mobility information satisfies the one or more thresholds can be indicative that a mobility event has occurred.

In some examples, each threshold can be associated with a respective mobility event, such that satisfaction of a threshold can indicate that the corresponding mobility event has occurred. In some examples, each threshold can be associated with an event definition for the mobility events. Table 1 includes the mobility events described herein. The thresholds can be associated with parameters corresponding to the mobility information, such as RSRP, RSRQ, SINR, hysteresis, offset, and cell specific offset. In some implementations, the thresholds can be dynamically configured (e.g., by the network) for the one or more CCs and/or one or more cells, such that the thresholds can be defined relative to a selected CC or a selected cell. Table 2 includes the thresholds described herein.

TABLE 1
Mobility Events

| Event | Description |
|---|---|
| Event A1 | Serving becomes better than threshold |
| Event A2 | Serving becomes worse than threshold |
| Event A3 | Neighbor becomes offset better than SpCell |
| Event A4 | Neighbor becomes better than threshold |
| Event A5 | SpCell becomes worse than threshold1 and neighbor |
| | becomes better than threshold2 |
| Event A6 | Neighbor becomes offset better than SCell |
| Event B1 | Inter-RAT neighbor becomes better than threshold |
| Event B2 | PCell becomes worse than threshold1 and inter-RAT |
| | neighbor becomes better than threshold2 |

TABLE 2
Mobility Thresholds

| Event | Parameter | Range | | Value | |
|---|---|---|---|---|---|
| A1, A2, A4, | RSRP Threshold | 0 | 127 | −156 | −31 |
| A5, B1 | RSRQ Threshold | 0 | 127 | −40 | 20 |
| | SINR Threshold | 0 | 127 | −23 | 40 |
| All | Hysteresis | 0 | 30 | 0 | 15 |
| A3, A6 | Offset | −30 | 30 | −15 | 15 |
| A3, A4, A5, | Cell Specific Offset | | | −24 | 24 |
| A6, B1, B2 | | | | | |
| B1, B2 | LTE RSRP | 0 | 97 | −140 | −44 |
| | LTE RSRQ | 0 | 34 | −19.5 | −3 |
| | LTE SINR | −23 | 40 | −23 | 40 |

In some scenarios, UE 210 can be provided with the one or more thresholds. For example, base station 222 can transmit an indication of the one or more thresholds to UE 210. In some such examples, base station 222 can provide the one or more thresholds for one or more CCs and/or one or more cells associated with UE 210. In some implementations, base station 222 can indicate whether the thresholds should be used for an individual CC or an individual cell, or whether the thresholds should be used for the CC group for CSI-RS or each cell of the one or more cells associated with UE 210.

As shown, process 500 can include generating a mobility report (block 570). That is, UE 210 can generate the mobility report based on determining the mobility information (at block 550) or detecting a mobility event (at block 560). The mobility report can include an indication of the mobility information or an indication of the mobility event occurring. For example, the mobility report can include values relevant to the thresholds (RSRP, RSRQ, SINR, hysteresis, offset, and cell specific offset). In some scenarios, the mobility report can include mobility information for one or more CCs of the CC group for CSI-RS and/or one or more cells.

As shown, process 500 can include communicating the mobility report (block 580). For example, UE 210 can transmit the mobility report to base station 222. In some scenarios, UE 210 can initiate transmitting the mobility report based on the mobility event occurring or based on receiving a request from base station 222. In other scenarios, UE 210 can initiate transmitting the mobility report based on the staggering schedule for communicating the CSI-RSs.

Process 500 can support leveraging CSI-RSs communicated via individual CCs of a CC group for CSI-RS based on implementing the staggering schedule for communicating CSI-RSs across the CC group for CSI-RS. Staggering the CSI-RSs communicated across the CC group for CSI-RS can provide durations (e.g., time gaps, slots) in the individual CCs that can be used for communicating other signaling such as PDSCH or physical broadcast channel (PBCH). Alternatively, staggering the CSI-RSs can provide durations that reduce resource utilization by the network, which can support NES.

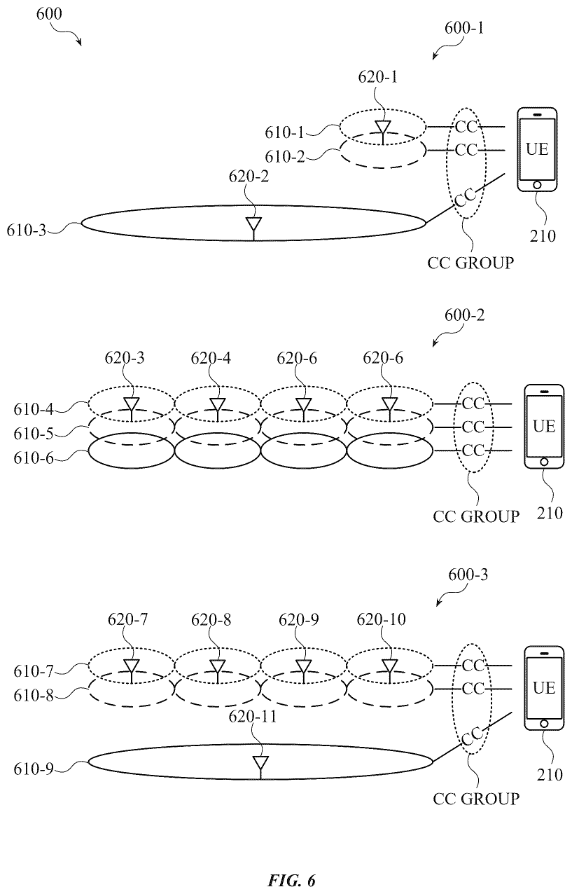

FIG. 6 is a diagram of example CC group layouts 600 according to one or more implementations described herein. As shown, example CC group layouts 600 can include CC group layout 600-1, CC group layout 600-2, and CC group layout 600-3. Example CC group layouts 600 can each include CCs that can be examples of CCs 130, as described with reference to FIG. 1. For example, CC group layout 600-1, CC group layout 600-2, and CC group layout 600-3 each include a different variation for how CCs can be implemented in a network, and include representative variations of a quantity of possible variations that can be implemented by a network.

CC group layout 600-1, CC group layout 600-2, and CC group layout 600-3 each include a CC group (e.g., a CC group for SSB, a CC group for CSI-RS) which can be implemented by a network for communicating with UE 210 (e.g., from base station 222). Each CC group can be defined as a CC-GroupForSSB and can be configured to leverage SSBs communicated on individual CCs of the CC group. For example, a CC-GroupForSSB can be defined as a set of CCs that support coverage across vertical frequencies in a given footprint. In some cases, the CC-GroupForSSB can be changed based on a NES function of individual CCs. That is, a CC of the CC-GroupForSSB can slow a transmission rate (e.g., to 160 ms) of the SSBs due to a lack of congestion within the CC-GroupForSSB. In some scenarios, a cadence for transmitting the SSBs and the selection of CCs to be included in the CC-GroupForSSB can be determined by the network dynamically and broadcast information can be adjusted accordingly.

Alternatively, each CC group can be defined as a CC-GroupForCSI-RS and can be configured to leverage CSI-RSs communicated on individual CCs of the CC group for CSI-RS. For example, a CC-GroupForCSI-RSs can be defined as a set of CCs that support coverage across vertical frequencies in a given footprint and accommodate measurement reporting information used for mobility thresholds determination and triggering of sending measurement reports from UE 210. In some examples, the CC-GroupForCSI-RSs can be a subset (e.g., a proper subset, an improper subset) of the CC-GroupForSSB. In some implementations, the set of CCs that can form a CC group for measurement reporting (e.g., a CC-GroupForCSI-RSs) can be different from a CC group for SSB monitoring (e.g., across CCs) by UE 210 based on CSI-RS measurement for mobility reporting behaviors and the association of different CCs across sites 620. In some scenarios, the CCs of a CC group (e.g., a CC group for SSB, a CC group for CSI-RS) can be collocated or non-collocated. In some such scenarios, the CC group (e.g., a CC group for CSI-RS) can support deployment scenarios that allow for grouping for measurement reporting. In some examples, each CC group (e.g., CC group for CSI-RS) can be defined differently based on the CCs being used to communicate other reference signals or reporting for downlink or uplink signaling.

In some scenarios, each CC group can be defined relative to CQI reporting such that a CC group for CQI reporting can be configured to leverage CSI-RSs communicated on individual CCs of the CC group for reporting CQI. For example, a CC group for CQI reporting can be defined as a set of CCs that can be a subset of the CC-GroupForSSB or a subset of the CC-GroupForCSI-RSs, or a subset of the CCs associated with one or more sites 620. In some such scenarios, based on CQI reporting behaviors and an association of the CCs across cells 610 (e.g., PSCells and SCells), the set of CCs that can be treated to be part of the CC group for CQI reporting can be different from the CC-GroupForSSB.

In some scenarios, the CSI-RSs can be reference signals associated with system camping and mobility and can be different from CSI-RSs used for channel estimation and CSI reporting. Thus, the CC group for CSI-RS associated with system camping and mobility can be different from a CC group for CSI-RS associated with channel estimation. Likewise, the CC group for CSI-RS associated with channel estimation can be different form a CC group for CSI reporting.

CC group layout 600-1, CC group layout 600-2, and CC group layout 600-3 each include a quantity of sites 620, where each site 620 can be an example of base station 222. For example, site 620-1, site 620-2, site 620-3, site 620-4, site 620-5, site 620-6, site 620-7, site 620-8, site 620-9, site 620-10, and site 620-11 can each be implemented as base station 222. As shown in FIG. 6, each site 620 can be associated with one or more CCs. For example, site 620-3, site 620-4, site 620-5, and site 620-6 are each associated with three respective CCs; site 620-1, site 620-7, site 620-8, site 620-9, and site 620-10 are each associated with two respective CCs; and site 620-2 and site 620-11 are each associated with one respective CC.

Each site 620 can be associated with one or more cells 610, which can be examples of PCells, PSCells, SCells, or neighboring cells. For example, site 620-3, site 620-4, site 620-5, and site 620-6 are each associated with three respective cells 610 (e.g., cell 610-4, cell 610-5, cell 610-6); site 620-1, site 620-7, site 620-8, site 620-9, and site 620-10 are each associated with three respective cells 610 (e.g., cell 610-1, cell 610-2, cell 610-7, cell 610-8); and site 620-2 and site 620-11 are each associated with one respective cell 610 (e.g., cell 610-3, cell 610-9). For example, if UE 210 is camped on site 620-7 (e.g., within a coverage area of site 620-7), site 620-7 can function as a PCell for UE 210. In some such examples, site 620-7 can function as PSCell or an SCell for UE 210 based on site 620-7 being associated with other cells. In other examples, site 620-8 or site 620-11 can function as an SCell or a neighboring cell for UE 210.

In some scenarios, sites 620 can be collocated or non-collocated, such that site 620-7 can be collocated with site 620-8 but non-collocated with site 620-11. In some such scenarios, collocated sites 620 can leverage SSBs (e.g., or CSI-RSs) transmitted via CCs of the same CC group (e.g., the CC group for SSB, the CC group for CSI-RS). For example, UE 210 can receive SSBs (e.g., or CSI-RSs) via CCs associated with collocated sites 620-7 and 620-8. However, in some cases, the network may not guarantee support for UE 210 receiving SSBs (e.g., or CSI-RSs) via CCs associated with non-collocated sites 620-7 and 620-11.

In some scenarios, sites 620 can be associated with different systems, such an FDD system or a TDD system. For example, site 620 operating as an FDD system can be associated with a larger coverage area or footprint (e.g., from a base station) than site 620 operating as a TDD system. In some such examples, UE 210 can be camped on site 620 operating as a TDD system, and can be operable to monitor neighboring site 620 operating as an FDD system. Further, UE 210 camped on site 620 operating as an FDD system can be operable to monitor neighboring site 620 operating as a TDD system. In some such examples, UE 210 can leverage SSBs communicated from a quantity of neighboring sites 620 operating as TDD systems. In some scenarios, site 620 operating as an FDD system can be configured to support transmissions that are asynchronous. For example, SSBs (e.g., or CSI-RSs) can be communicated asynchronously from site 620 operating as an FDD system to UE 210. In some scenarios, site 620 operating as a TDD system can be configured to support transmissions that are synchronous, such that SSBs (e.g., or CSI-RSs) can be transmitted synchronously from site 620 to UE 210. In some examples, although SSBs can be transmitted asynchronously for site operating as an FDD system, a timing between site 620 and another site 620 operating as a TDD system can be coarsely aligned by UE 210.

In some scenarios, each site 620 can be configured to deploy multiple CCs in a given footprint such that the CCs can share antenna configurations spanning across frequency bands. For example, each CC in a mid-band frequency can be associated with 32 transmission antennas, whereas each CC in a low-band frequency can be associated with 4 transmission antennas. In some such examples, UE 210 can be configured to report reference signal received power (RSRP), reference signal received quality (RSRQ), or signal interference noise ratio (SINR) for a CC within a frequency band. In some implementations, the RSRP, RSRQ, and SINR for a CC within a frequency band can correlate to the RSRP, RSRQ, and SINR for other CCs within the frequency band.

UE 210 can be configured to leverage SSBs or CSI-RSs communicated via an individual CC of the CC group (e.g., the CC group for SSB, the CC group for CSI-RS). For example, UE 210 can be camped on site 620-1 and can establish and maintain a connection with site 620-1 using a CC of the CC group (e.g., the CC group for SSB, the CC group for CSI-RS) associated with site 620-1. In some such examples, UE 210 can leverage the connection with site 620-1 using the CC to communicate with site 620-1 using other CCs of the CC group (e.g., the CC group for SSB, the CC group for CSI-RS). That is, with overlapping footprints across the CC group (e.g., the CC group for SSB, the CC group for CSI-RS), UE 210 can leverage SSBs available via another CC of the CC group (e.g., the CC group for SSB, the CC group for CSI-RS), even if UE 210 is camped on a given frequency.

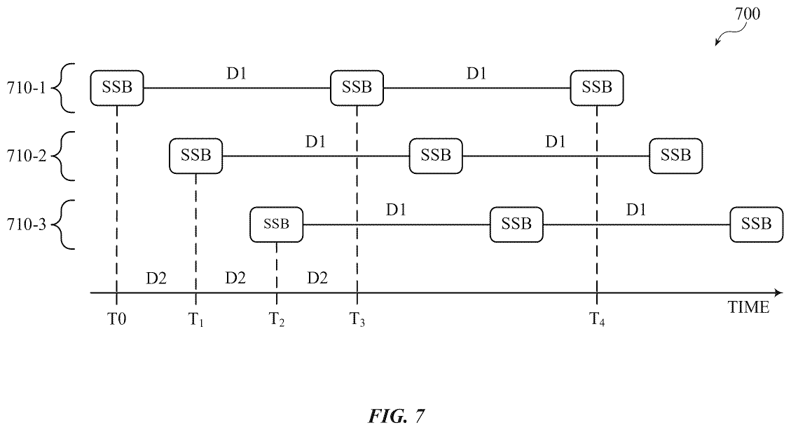

FIG. 7 is a diagram of an example signal timing 700 according to one or more implementations described herein. Signal timing 700 includes a staggering schedule for communicating SSBs on CCs 710 (e.g., CC 710-1, CC 710-2, CC 710-3) between a UE (e.g., UE 210) and one or more base stations (e.g., base station 222). That is, signal timing 700 includes communicating (e.g., transmitting) a series of SSBs (e.g., three SSBS) on each CC 710 based on the staggering schedule. For each CC 710, a duration D1 can elapse between the communication of each SSB of the series of SSBs. For example, a second SSB of the series can be communicated after the duration D1 has elapsed since communicating a first SSB of the series, and a third SSB of the series can be communicated after the duration D1 has elapsed since communicating the second SSB of the series. For example, a first SSB of the series of SSBs communicated on CC 610-1 is included at a time TO, a second SSB of the series is included at a time T3, and a third SSB of the series is included at a time T4, where the duration D1 is included between the time T0 and the time T3 and between the time T3 and the time T4. In some implementations, the duration D1 can be a fixed value (e.g., 60 ms) or a value dynamically configured by the network or the UE. Although signal timing 700 includes each series of SSBs as including three SSBs, it should be understood that the staggering schedule described herein can be applied to continuous series of SSBs.

Each series of SSBs communicated on each CC 710 can be offset (e.g., staggering) from one another. That is, the series of SSBs communicated on CC 710-3 can be offset from the series of SSBs communicated on CC 710-2, which can be offset from the series of SSBs communicated on CC 710-1. For example, a first SSB (e.g., a second SSB, a third SSB) of the series of SSBs communicated on CC 710-3 can be offset from the first SSB (e.g., a second SSB, a third SSB) of the series of SSBs communicated on CC 710-2, which can be offset from the first SSB (e.g., a second SSB, a third SSB) of the series of SSBs communicated on CC 710-1. In some examples, each series of SSBs can be offset by a duration D2, such that the series of SSBs communicated on CC 710-3 can be offset from the series of SSBs communicated on CC 710-2 by the duration D2, and the series of SSBs communicated on CC 710-2 can be offset from the series of SSBs communicated on CC 710-1 by the duration D2. For example, a first SSB of the series of SSBs communicated on CC 710-1 is included as being communicated at time TO, and the first SSB of the series of SSBs communicated on CC 710-2 is included as being communicated at time T1, where the time T1 is offset from the time TO by the duration D2. Likewise, a first SSB of the series of SSBs communicated on CC 710-3 is included as being communicated at time T2, where the time T2 is offset from the time T1 by the duration D2 (e.g., and offset from the time T0 by the duration 2*(D2)).

In some scenarios, an SSB of each CC 710 can be communicated within the duration D1 such that the offset between SSBs of different series is a factor of the duration D2. For example, the duration D2 is a factor of the duration D1, such that each duration D1 is associated with three durations D2. That is, the second SSB of a series can be offset from the first SSB of a different series by the duration D2. For example, the second SSB of the series of SSBs communicated on CC 710-1 is offset from the first SSB of the series of SSBs communicated on CC 710-3 by the duration D2. That is, the time T3 is offset from the time T2 by the duration D2. In some examples, the duration D2 can be a fixed value (e.g., 20 ms) or a value dynamically configured by the network or the UE.

Signal timing 700 includes duty cycling the SSBs across CCs 710 (e.g., which can be facilitated by the network) to aid NES. That is, signal timing 700 includes SSBs being communicated on CCs 710 such that a UE can receive SSBs with a same periodicity as previous implementations (e.g., current deployments). For example, in traditional applications, SSBs can be transmitted along each CC 710 at a rate of 20 ms. However, because the UE can leverage SSBs from individual CCs 710 of the CC group for SSB (e.g., including CC 710-1, CC 710-2, CC 710-3) while the network is operating CCs 710 in a collaborative manner, the SSBs can be staggered within the CC group for SSB such that the UE can receive an SSB from one of CCs 710 of the CC group for SSB every 20 ms, even though each CC 710 is transmitting SSBs at an individual rate of 60 ms. Implementing the techniques described herein can enable a network to reduce (e.g., compared to previous implementations) the periodicity of communicating SSBs on a given CC 710, thereby supporting NES.

In some scenarios, parameters associated with duty cycling the SSBs across CCs 710 can be dependent on duty cycling across the beams of a given cell. Likewise, an extent of the duty cycling can be dependent on the available set of frequencies in a given coverage area (e.g., associated with the given cell). In some such scenarios, increasing SSB presence can be based on duty cycling choices (e.g., by the network) made across CCs 710 and/or the beams, thereby allowing the UE to perform channel assessment and link maintenance.

In some scenarios, the staggering schedule of signal timing 700 can be provided to the UE (e.g., as part of a system information block (SIB) such as SIB2 or SIB4). For example, the network (e.g., from a base station) can transmit an indication (e.g., ssb-ToMeasure) to the UE identifying duty cycle information including the periodicity of repetition with each CC 710. In some such examples, the network can provide a single value representative of the periodicity for every CC 710 of the CC group for SSB, or independent values representative of the periodicity for each individual CC 710 of the CC group for SSB. Receiving the indication can enable the UE to assess the timing of the SSBs communicated across CCs 710 when the UE is camped on a given CC 710. In some cases, each site (e.g., base station 120, base station 222) can be configured to dynamically select whether to implement the staggering schedule described herein.

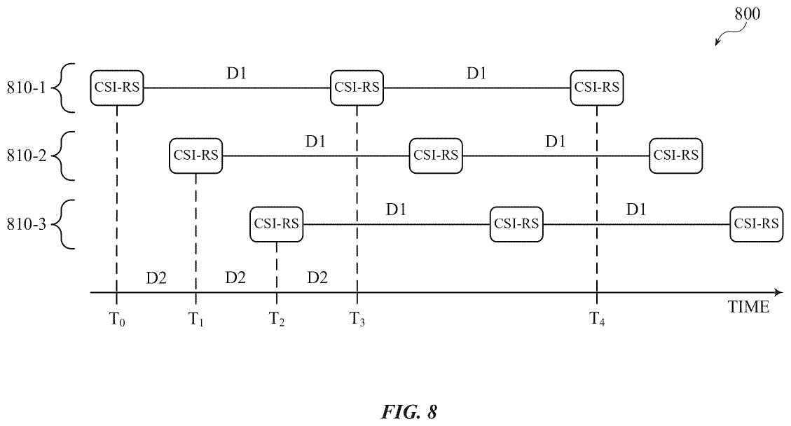

FIG. 8 is a diagram of an example signal timing 800 according to one or more implementations described herein. Signal timing 800 includes a staggering schedule for communicating CSI-RSs on CCs 810 (e.g., CC 810-1, CC 810-2, CC 810-3) between a UE (e.g., UE 210) and one or more base stations (e.g., base station 222). That is, signal timing 800 includes communicating (e.g., transmitting) a series of CSI-RSs (e.g., three CSI-RSs) on each CC 810 based on the staggering schedule. For each CC 810, a duration D1 can elapse between the communication of each CSI-RS of the series of CSI-RSs. For example, a second CSI-RS of the series can be communicated after the duration D1 has elapsed since communicating a first CSI-RS of the series, and a third CSI-RS of the series can be communicated after the duration D1 has elapsed since communicating the second CSI-RS of the series. For example, a first CSI-RS of the series of CSI-RSs communicated on CC 810-1 is included at a time TO, a second CSI-RS of the series is included at a time T3, and a third CSI-RS of the series is included at a time T4, where the duration D1 is included between the time T0 and the time T3 and between the time T3 and the time T4. In some implementations, the duration D1 can be a fixed value (e.g., 120 ms) or a value dynamically configured by the network or the UE. Although signal timing 800 includes each series of CSI-RSs as including three CSI-RSs, it should be understood that the staggering schedule described herein can be applied to continuous series of CSI-RSs.

Each series of CSI-RSs communicated on each CC 810 can be offset (e.g., staggered) from one another. That is, the series of CSI-RSs communicated on CC 810-3 can be offset from the series of CSI-RSs communicated on CC 810-2, which can be offset from the series of CSI-RSs communicated on CC 810-1. For example, a first CSI-RS (e.g., a second CSI-RS, a third CSI-RS) of the series of CSI-RSs communicated on CC 810-3 can be offset from the first CSI-RS (e.g., a second CSI-RS, a third CSI-RS) of the series of CSI-RSs communicated on CC 810-2, which can be offset from the first CSI-RS (e.g., a second CSI-RS, a third CSI-RS) of the series of CSI-RSs communicated on CC 810-1.

In some examples, each series of CSI-RSs can be offset by a duration D2, such that the series of CSI-RSs communicated on CC 810-3 can be offset from the series of CSI-RSs communicated on CC 810-2 by the duration D2, and the series of CSI-RSs communicated on CC 810-2 can be offset from the series of CSI-RSs communicated on CC 810-1 by the duration D2. For example, a first CSI-RS of the series of CSI-RSs communicated on CC 810-1 is included as being communicated at time TO, and the first CSI-RS of the series of CSI-RSs communicated on CC 810-2 is included as being communicated at time T1, where the time T1 is offset from the time TO by the duration D2. Likewise, a first CSI-RS of the series of CSI-RSs communicated on CC 810-3 is included as being communicated at time T2, where the time T2 is offset from the time T1 by the duration D2 (e.g., and offset from the time TO by the duration 2*(D2)).

In some scenarios, a CSI-RS of each CC 810 can be communicated within the duration D1 such that the offset between CSI-RSs of different series is a factor of the duration D2. For example, the duration D2 is a factor of the duration D1, such that each duration D1 is associated with three durations D2. That is, the second CSI-RS of a series can be offset from the first CSI-RS of a different series by the duration D2. For example, the second CSI-RS of the series of CSI-RSs communicated on CC 810-1 is offset from the first CSI-RS of the series of CSI-RSs communicated on CC 810-3 by the duration D2. That is, the time T3 is offset from the time T2 by the duration D2. In some examples, the duration D2 can be a fixed value (e.g., 40 ms) or a value dynamically configured by the network or the UE.

Signal timing 800 includes duty cycling the CSI-RSs across CCs 810 (e.g., which can be facilitated by the network) to aid NES. That is, signal timing 800 includes CSI-RSs being communicated on CCs 810 such that a UE can receive CSI-RSs with a same periodicity as previous implementations (e.g., current deployments). For example, in traditional applications, CSI-RSs can be transmitted along each CC 810 at a rate of 40 ms. However, because the UE can leverage CSI-RSs from individual CCs 810 of the CC group for CSI-RS (e.g., including CC 810-1, CC 810-2, CC 810-3) while the network is operating CCs 810 in a collaborative manner, the CSI-RSs can be staggering within the CC group for CSI-RS such that the UE can receive a CSI-RS from one of CCs 810 of the CC group for CSI-RS every 40 ms, even though each CC 810 is transmitting CSI-RSs at an individual rate of 120 ms. Implementing the techniques described herein can enable a network to reduce (e.g., compared to previous implementations) the periodicity of communicating CSI-RSs on a given CC 810, thereby supporting NES.

The network can be capable of configuring the staggering schedule for communicating the CSI-RSs via CCs 810. For example, the network can determine a CSI-RS is selected for performing mobility measurements at the UE, and the network can provision the CSI-RSs for CCs 810 of the CC group for CSI-RS such that the CSI-RS is aligned with the duty cycling of the CSI-RSs. In some scenarios, the network can configure the staggering schedule to account for the CSI-RSs being available for performing mobility measurements. In some such scenarios, the CSI-RSs can be scheduled such that the CSI-RSs are available prior to a reporting schedule of the mobility measurements for a given CC 810. That is, the UE can be configured to communicate mobility measurement reports based on a cadence defined by the staggering schedule of the CSI-RSs and provided by the network. Additionally, or alternatively, the CSI-RSs can be aligned to support measurement gaps for reporting the mobility measurements in accordance with the reporting schedule. The techniques described herein can support reporting from the UE based on using the relatively most recent CSI-RS for performing mobility measurements.

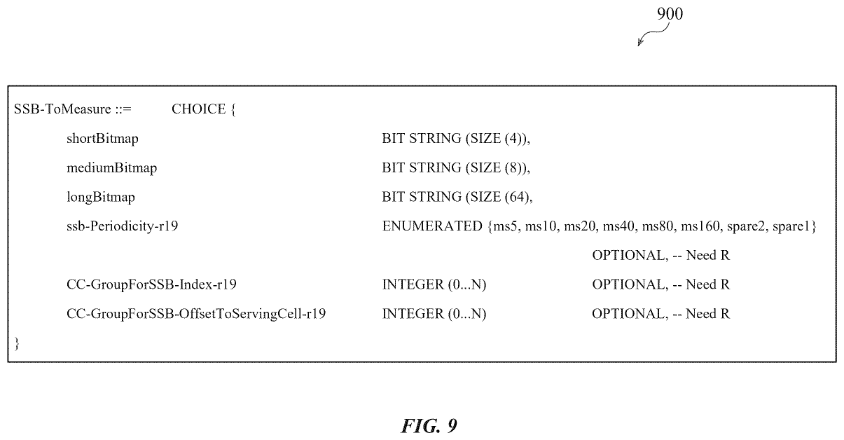

FIG. 9 is a diagram of an example data structure 900 for supporting transmissions according to one or more implementations described herein. Data structure 900 is directed to an ssb-ToMeasure information element, which can be transmitted from a base station (e.g., base station 222) to a UE (e.g., UE 210). The ssb-ToMeasure information element can be included in an SIB communicated to the UE, indicating to the UE which CCs are associated with a CC group for SSB and duty cycling information associated with the SSBs provided via the CCs of the CC group for SSB. For example, the ssb-ToMeasure information element can indicate a periodicity of the SSBs transmitted for a given CC. In some such examples, the ssb-ToMeasure information element can also indicate a periodicity for inter-frequency neighboring CCs. The ssb-ToMeasure information element can provide an index of the given CC of the CC group for SSB, which can be used to determine a duty cycling position of the CC as the network cycles through the CCs of the CC group for SSB. In some such examples, the ssb-ToMeasure information element can also provide one or more indexes associated with inter-frequency neighboring CCs. The ssb-ToMeasure information element can provide an approximate time offset associated with the CC communicating SSBs for the cell associated with the UE. In some such examples, the ssb-ToMeasure information element can also provide the approximate time offset for FDD and/or TDD inter-frequency neighboring CCs. Table 3 includes descriptions for the fields included in data structure 900.

TABLE 3
ssb-ToMeasure Field Descriptions

ssb-Periodicity-r19
The periodicity of the SSBs transmitted in a given CC. Optionally
included for inter-frequency neighbors.
CC-Group-Index-r19
Provides the index of the CC within the CC-group. The index is
used to determine the duty cycling position as the network cycles
through the CC within the CC-group. Optionally included for
inter-frequency neighbors.
CC-GroupForSSB-OffsetToServingCell-r19
Provide an approximate offset in time measured in number of slots
relative to the current serving cell where the CC is supporting
the SSB transmissions. Optionally included for FDD / TDD
inter-frequency neighbours.

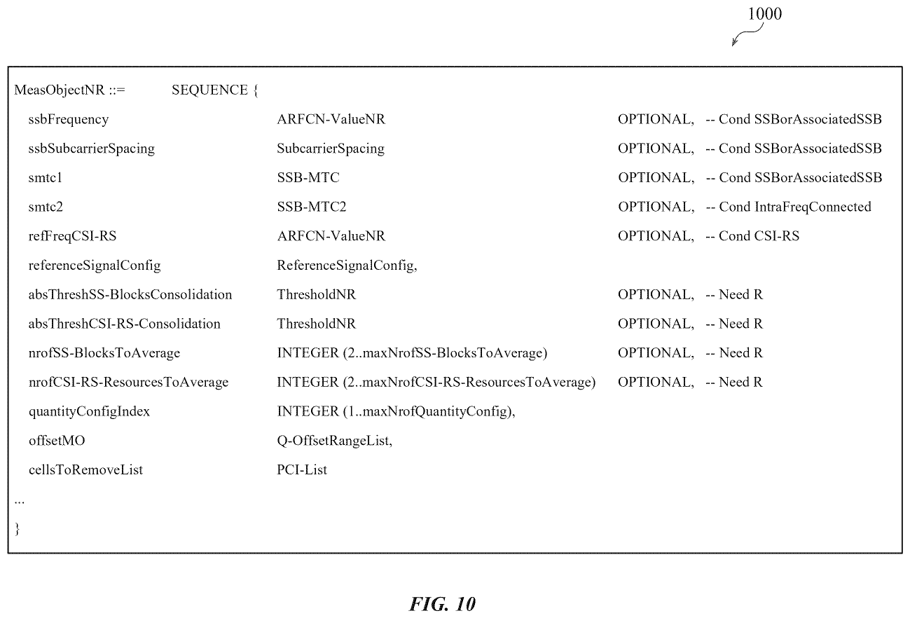

FIG. 10 is a diagram of an example data structure 1000 for supporting mobility measurements according to one or more implementations described herein. Data structure 1000 is directed to a MeasObjectNR information element, which can be transmitted from a base station (e.g., base station 222) to a UE (e.g., UE 210). The MeasObjectNR information element can be provided to the UE indicating how the UE can perform mobility measurements for determining mobility information. For example, the MeasObjectNR information element can specify how the UE can collect mobility measurements, including averaging measurements across CCs of a CC group for CSI-RS. In some scenarios, the base station can transmit the MeasObjectNR information element as part of a CSI configuration using RRC signaling, or using a downlink control channel or MAC-CE signaling. In some examples, the MeasObjectNR information element can include information applicable for PBCH blocks intra-frequency and inter-frequency measurements, and CSI-RS intra-frequency and inter-frequency measurements. In some examples, the MeasObjectNR information element can indicate a maximum number of measurement results per beam based on CSI-RS resources to be averaged. For example, a same value can apply for each detected cell associated with the MeasObjectNR information. In some examples, the MeasObjectNR information element can indicate a maximum number of measurement results per beam based on PBCH blocks to be averaged. For example, a same value can apply for each detected cell associated with the MeasObjectNR information. Table 4 includes descriptions for the fields included in data structure 900.

TABLE 4
MeasObjectNR Field Descriptions

nrofCSInrofCSI-RS-ResourcesToAverage
Indicates the maximum number of measurement results per beam based
on CSI-RS resources to be averaged. The same value applies for each
detected cell associated with this MeasObjectNR.
nrofSS-BlocksToAverage
Indicates the maximum number of measurement results per beam based
on SS/PBCH blocks to be averaged. The same value applies for each
detected cell associated with this MeasObject.

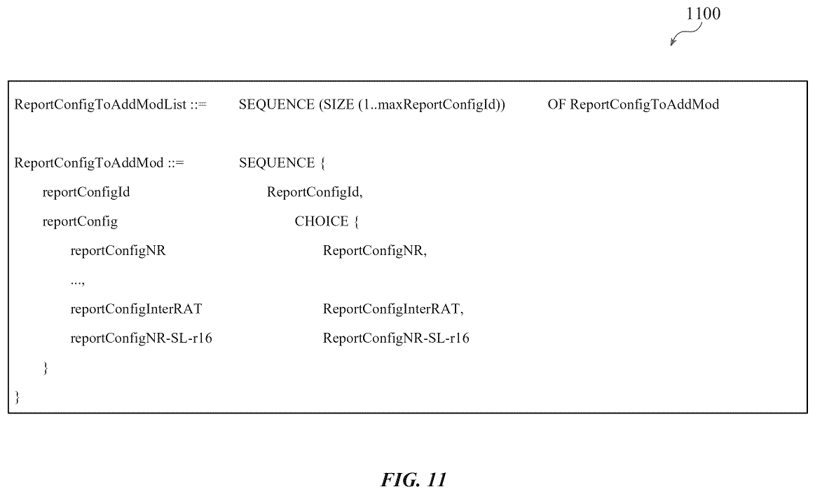

FIG. 11 is a diagram of an example data structure 1100 for supporting reporting according to one or more implementations described herein. Data structure 1100 is directed to information that can be transmitted as part of mobility reports from a UE (e.g., UE 210) to a base station (e.g., base station 222). For example, data structure 1100 includes a ReportConfigToAddModList which can define a list of reporting configurations associated with the mobility reports.

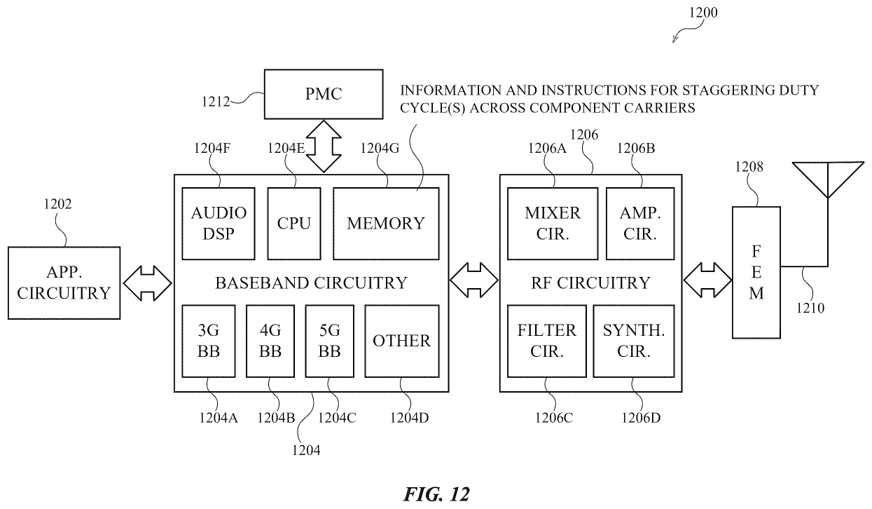

FIG. 12 is a diagram of an example of components of a device according to one or more implementations described herein. In some implementations, device 1200 can include application circuitry 1202, baseband circuitry 1204, RF circuitry 1206, front-end module (FEM) circuitry 1208, one or more antennas 1210, and power management circuitry (PMC) 1212 coupled together at least as shown. In some implementations, device 1200 can include fewer elements (e.g., a RAN node may not utilize application circuitry 1202, and can instead include a processor/controller to process data received from a core network. In some implementations, device 1200 can include additional elements such as, for example, memory/storage, display, camera, sensor (including one or more temperature sensors, such as a single temperature sensor, a plurality of temperature sensors at different locations in device 1200, etc.), or input/output (I/O) interface. In other implementations, the components described below can be included in more than one device (e.g., said circuitries can be separately included in more than one device for cloud-RAN (C-RAN) implementations).

Application circuitry 1202 can include one or more application processors. For example, application circuitry 1202 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on device 1200. In some implementations, processors of application circuitry 1202 can process data packets received from a core network.

Baseband circuitry 1204 can include circuitry such as, but not limited to, one or more single-core or multi-core processors. Baseband circuitry 1204 can include one or more baseband processors or control logic to process baseband signals received from a receive signal path of RF circuitry 1206 and to generate baseband signals for a transmit signal path of RF circuitry 1206. Baseband circuitry 1204 can interface with application circuitry 1202 for generation and processing of the baseband signals and for controlling operations of RF circuitry 1206. For example, in some implementations, baseband circuitry 1204 can include a 3G baseband processor 1204A, a 4G baseband processor 1204B, a 5G baseband processor 1204C, or other baseband processor(s) 1204D for other existing generations, generations in development or to be developed in the future (e.g., 5G, 6G, 7G, etc.). Baseband circuitry 1204 (e.g., one or more of baseband processors 1204A-D) can handle various radio control functions that enable communication with one or more radio networks via RF circuitry 1206. In other implementations, some, or all of the functionality of baseband processors 1204A-D can be included in modules stored in memory 804G and executed via central processing unit (CPU) 804E. The radio control functions can include, but are not limited to, signal modulation/demodulation, encoding/decoding, radio frequency shifting, etc. In some implementations, modulation/demodulation circuitry of baseband circuitry 804 can include Fast-Fourier Transform (FFT), precoding, or constellation mapping/de-mapping functionality. In some implementations, encoding/decoding circuitry of baseband circuitry 804 can include convolution, tail-biting convolution, turbo, Viterbi, or low-density parity check (LDPC) encoder/decoder functionality. Implementations of modulation/demodulation and encoder/decoder functionality are not limited to these examples and can include other suitable functionality in other implementations.

In some implementations, memory 1204G can receive and/or store information and instructions for enabling UE 210, and/or one or more components thereof, to communicate SSBs and/or CSI-RSs via a single CC of a CC group (e.g., a CC group for SSB, a CC group for CSI-RS). For example, the information and instructions can cause and/or enable UE 210 to receive SSBs or CSI-RSs according to a staggering schedule associated with the respective CC group (e.g., the CC group for SSB, the CC group for CSI-RS). UE 210 can use the SSBs to perform one or more synchronization operations, or UE 210 can use the CSI-RSs to perform mobility measurements associated with the respective CC group for CSI-RS. By enabling UE 210 to receive an SSB/CSI-RS from a single CC of the CC group (e.g., the CC group for SSB, the CC group for CSI-RS) rather than from each CC of the CC group (e.g., the CC group for SSB, the CC group for CSI-RS), the network can experience improved NES due to reduced resource consumption, among other advantages. These and many other features and examples are described herein.

In some implementations, baseband circuitry 1204 can include one or more audio digital signal processor(s) (DSP) 1204F. audio DSPs 1204F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of baseband circuitry 1204 and application circuitry 1202 can be implemented together such as, for example, on a system on a chip (SOC).

In some implementations, baseband circuitry 1204 can provide for communication compatible with one or more radio technologies. For example, in some implementations, baseband circuitry 1204 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which baseband circuitry 1204 is configured to support radio communications of more than one wireless protocol can be referred to as multi-mode baseband circuitry.

RF circuitry 1206 can enable communication with wireless networks using modulated electromagnetic radiation through a non-solid medium. In various implementations, RF circuitry 806 can include switches, filters, amplifiers, etc., to facilitate the communication with the wireless network. RF circuitry 1206 can include a receive signal path which can include circuitry to down-convert RF signals received from FEM circuitry 1208 and provide baseband signals to baseband circuitry 1204. RF circuitry 1206 can also include a transmit signal path which can include circuitry to up-convert baseband signals provided by baseband circuitry 804 and provide RF output signals to FEM circuitry 1208 for transmission.

In some implementations, the receive signal path of RF circuitry 1206 can include mixer circuitry 1206A, amplifier circuitry 1206B and filter circuitry 1206C. In some implementations, the transmit signal path of RF circuitry 1206 can include filter circuitry 1206C and mixer circuitry 1206A. RF circuitry 1206 can also include synthesizer circuitry 1206D for synthesizing a frequency for use by mixer circuitry 1206A of the receive signal path and the transmit signal path. In some implementations, mixer circuitry 1206A of the receive signal path can be configured to down-convert RF signals received from FEM circuitry 1208 based on the synthesized frequency provided by synthesizer circuitry 1206D. Amplifier circuitry 1206B can be configured to amplify the down-converted signals and filter circuitry 1206C can be a low-pass filter (LPF) or band-pass filter (BPF) configured to remove unwanted signals from the down-converted signals to generate output baseband signals. Output baseband signals can be provided to baseband circuitry 1204 for further processing. In some implementations, the output baseband signals can be zero-frequency baseband signals, although this may not be a requirement. In some implementations, mixer circuitry 1206A of the receive signal path can comprise passive mixers, although the scope of the implementations is not limited in this respect.

In some implementations, mixer circuitry 1206A of the transmit signal path can be configured to up-convert input baseband signals based on the synthesized frequency provided by synthesizer circuitry 1206D to generate RF output signals for FEM circuitry 1208. The baseband signals can be provided by baseband circuitry 1204 and can be filtered by filter circuitry 1206C.

In some implementations, mixer circuitry 1206A of the transmit signal path can be configured to up-convert input baseband signals based on the synthesized frequency provided by synthesizer circuitry 1206D to generate RF output signals for FEM circuitry 1208. The baseband signals can be provided by baseband circuitry 1204 and can be filtered by filter circuitry 1206C. In some implementations, mixer circuitry 1206A of the receive signal path and mixer circuitry 1206A of the transmit signal path can include two or more mixers and can be arranged for quadrature down conversion and up conversion, respectively. In some implementations, mixer circuitry 1206A of the receive signal path and mixer circuitry 1206A of the transmit signal path can include two or more mixers and can be arranged for image rejection. In some implementations, mixer circuitry 1206A of the receive signal path and mixer circuitry 1206A can be arranged for direct down conversion and direct up conversion, respectively. In some implementations, mixer circuitry 1206A of the receive signal path and mixer circuitry 1206A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, RF circuitry 1206 can include analog-to-digital converter (ADC) and digital-to-analog converter (DAC) circuitry and baseband circuitry 1204 can include a digital baseband interface to communicate with RF circuitry 1206.

In some dual-mode implementations, a separate radio IC circuitry can be provided for processing signals for each spectrum, although the scope of the implementations is not limited in this respect. In some implementations, synthesizer circuitry 1206D can be a fractional-N synthesizer or a fractional N/N+1 synthesizer, although the scope of the implementations is not limited in this respect as other types of frequency synthesizers can be suitable. For example, synthesizer circuitry 1206D can be a delta-sigma synthesizer, a frequency multiplier, or a synthesizer comprising a phase-locked loop with a frequency divider.

Synthesizer circuitry 1206D can be configured to synthesize an output frequency for use by mixer circuitry 1206A of RF circuitry 1206 based on a frequency input and a divider control input. In some implementations, synthesizer circuitry 1206D can be a fractional N/N+1 synthesizer. In some implementations, frequency input can be provided by a voltage-controlled oscillator (VCO). Divider control input can be provided by either baseband circuitry 1204 or applications circuitry 1202 depending on the desired output frequency. In some implementations, a divider control input (e.g., N) can be determined from a look-up table based on a channel indicated by applications circuitry 1202.

Synthesizer circuitry 1206D of RF circuitry 1206 can include a divider, a delay-locked loop (DLL), a multiplexer, and a phase accumulator. In some implementations, the divider can be a dual modulus divider (DMD), and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump, and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1206D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, RF circuitry 1206 can include an in-phase/quadrature (I/Q)/polar converter.

FEM circuitry 1208 can include a receive signal path which can include circuitry configured to operate on RF signals received from one or more antennas 1210, amplify the received signals and provide the amplified versions of the received signals to RF circuitry 1206 for further processing. FEM circuitry 1208 can also include a transmit signal path which can include circuitry configured to amplify signals for transmission provided by RF circuitry 1206 for transmission by one or more of the one or more antennas 1210. In various implementations, the amplification through the transmit or receive signal paths can be done solely in RF circuitry 1206, solely in FEM circuitry 1208, or in both RF circuitry 1206 and FEM circuitry 1208.

In some implementations, FEM circuitry 1208 can include a TX/RX switch to switch between transmit mode and receive mode operation. The FEM circuitry 1208 can include a receive signal path and a transmit signal path. The receive signal path of the FEM circuitry can include an LNA to amplify received RF signals and provide the amplified received RF signals as an output (e.g., to RF circuitry 1206). The transmit signal path of FEM circuitry 1208 can include a power amplifier (PA) to amplify input RF signals (e.g., provided by RF circuitry 1206), and one or more filters to generate RF signals for subsequent transmission (e.g., by one or more of the one or more antennas 1210).

In some implementations, PMC 1212 can manage power provided to baseband circuitry 1204. In particular, PMC 1212 can control power-source selection, voltage scaling, battery charging, or direct current (DC) to DC (DC-to-DC) conversion. PMC 1212 can often be included when device 1200 is capable of being powered by a battery, for example, when device 1200 is included in a UE. PMC 1212 can increase the power conversion efficiency while providing desirable implementation size and heat dissipation characteristics.

While FIG. 12 shows PMC 1212 coupled only with baseband circuitry 1204, in other implementations, PMC 1212 can be additionally or alternatively coupled with, and perform similar power management operations for, other components such as, but not limited to, application circuitry 1202, RF circuitry 1206, or FEM circuitry 1208.

In some implementations, PMC 1212 can control, or otherwise be part of, various power saving mechanisms of device 1200. For example, if device 1200 is in an RRC_Connected state, where device 1200 is still connected to RAN node as device 1200 expects to receive traffic shortly, then device 1200 can enter a state known as discontinuous reception mode (DRX) after a period of inactivity. During this state, device 1200 can power down for brief intervals of time and thus save power.

If there is no data traffic activity for an extended period of time, then device 1200 can transition off to an RRC_Idle state, where device 1200 disconnects from the network and does not perform operations such as channel quality feedback, handover, etc. Device 1200 can go into a very low power state and device 1200 can perform paging where again device 1200 periodically can wake up to listen to the network and then power down again. Device 1200 may not receive data in this state; in order to receive data, device 1200 can transition back to RRC_Connected state.

An additional power saving mode can allow a device to be unavailable to the network for periods longer than a paging interval (ranging from seconds to a few hours). During this time, device 1200 can be unreachable to the network and can power down completely. Any data sent during this time can incur a large delay and device 1200 can assume the delay is acceptable.

Processors of application circuitry 1202 and processors of baseband circuitry 1204 can be used to execute elements of one or more instances of a protocol stack. For example, processors of baseband circuitry 1204, alone or in combination, can be used execute Layer 3, Layer 2, or Layer 1 functionality, while processors of baseband circuitry 1204 can utilize data (e.g., packet data) received from these layers and further execute Layer 4 functionality (e.g., transmission communication protocol (TCP) and user datagram protocol (UDP) layers). As referred to herein, Layer 3 can comprise a radio resource control layer. As referred to herein, Layer 2 can comprise a medium access control layer, a radio link control layer, and a packet data convergence protocol layer, described in further detail below. As referred to herein, Layer 1 can comprise a physical layer of a UE/RAN node.

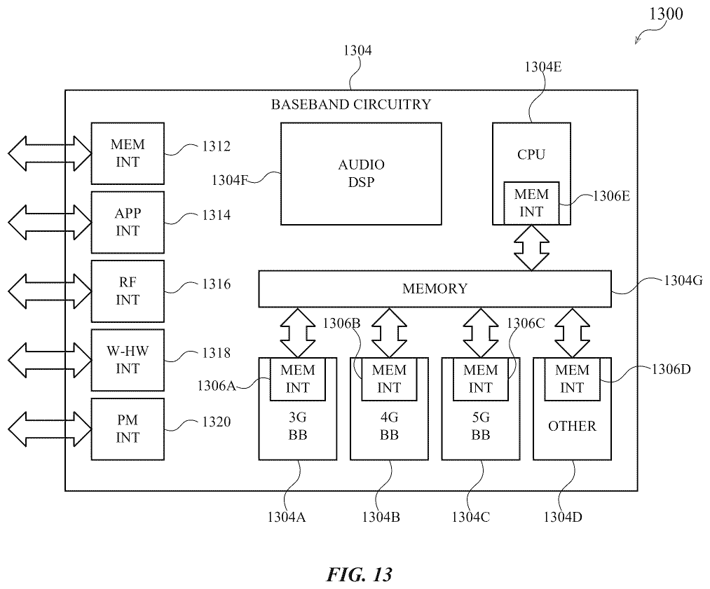

FIG. 13 is a diagram of example interfaces 1300 of baseband circuitry according to one or more implementations described herein. One or more components or features of example interfaces 1300 can correspond to one or more components or features described above or elsewhere. Baseband circuitry 1304 can comprise processors 1304A, 1304B, 1304C, 1304D, and 1304E and memory 1304G utilized by said processors. Each of processors 1304A, 1304B, 1304C, 1304D, and 1304E can include memory interface 1306A, 1306B, 1306C, 1306D, and 1306E, respectively, to send/receive data to/from memory 1304G. Baseband circuitry can be a component of a UE and/or another type of device or system capable of transmitting and/or receiving wireless signals.

In some implementations, memory 1304G can receive, store, and/or provide information and instructions for leveraging SSBs and/or CSI-RSs received via a single CC of a CC group (e.g., a CC group for SSB, a CC group for CSI-RS). For example, the information and instructions can cause and/or enable baseband circuitry 1304 to receive SSBs or CSI-RSs according to a staggering schedule associated with the respective CC group (e.g., the CC group for SSB, the CC group for CSI-RS). Baseband circuitry 1304 can use the SSBs to perform one or more synchronization operations, or baseband circuitry 1304 can use the CSI-RSs to perform mobility measurements associated with the respective CC group for CSI-RS. By enabling baseband circuitry 1304 to receive an SSB/CSI-RS from a single CC of the CC group (e.g., the CC group for SSB, the CC group for CSI-RS) rather than from each CC of the CC group (e.g., the CC group for SSB, the CC group for CSI-RS), the network can experience improved NES due to reduced resource consumption, among other advantages. These and many other features and examples are described herein.

Baseband circuitry 1304 can further include one or more interfaces to communicatively couple to other circuitries/devices, such as memory interface 1312 (e.g., an interface to send/receive data to/from memory external to baseband circuitry 1304), an application circuitry interface 1314 (e.g., an interface to send/receive data to/from the application circuitry as described herein), an RF circuitry interface 1316, wireless hardware connectivity interface 1318 (e.g., an interface to send/receive data to/from Near Field Communication (NFC) components, Bluetooth® components (e.g., Bluetooth® Low Energy), Wi-Fi® components, and other communication components), and a power management interface 1320 (e.g., an interface to send/receive power or control signals to/from a PMC)

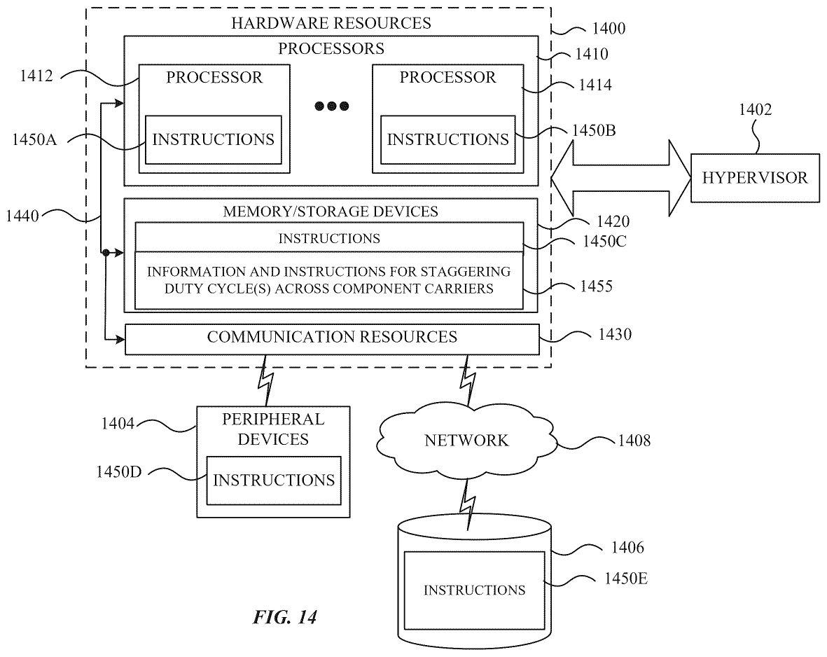

FIG. 14 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 14 shows a diagrammatic representation of hardware resources 1400 including one or more processors 1410 (or processor cores), one or more memory/storage devices 1420, and one or more communication resources 1430, each of which can be communicatively coupled via bus 1440. For implementations where node virtualization or network function virtualization is utilized, a hypervisor can be executed to provide an execution environment for one or more network slices/sub-slices to utilize hardware resources 1400. Hardware resources 1400 can interact with hypervisor 1402. For example, hypervisor 1402 can schedule or otherwise manage hardware resource 1400.

Processors 1410 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) can include, for example, processor 1412 and processor 1414.

Memory/storage devices 1420 can include main memory, disk storage, or any suitable combination thereof. Memory/storage devices 1420 can include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 1420 receive and/or store information and instructions 1455 for leveraging SSBs and/or CSI-RSs received via a single CC of a CC group (e.g., a CC group for SSB, a CC group for CSI-RS). For example, the information and instructions can cause and/or enable receiving SSBs or CSI-RSs according to a staggering schedule associated with the respective CC group (e.g., the CC group for SSB, the CC group for CSI-RS). The SSBs to perform one or more synchronization operations, and the CSI-RSs can be used to perform mobility measurements associated with the respective CC group for CSI-RS. By enabling the receiving an SSB/CSI-RS from a single CC of the CC group (e.g., the CC group for SSB, the CC group for CSI-RS) rather than from each CC of the CC group (e.g., the CC group for SSB, the CC group for CSI-RS), the network can experience improved NES due to reduced resource consumption, among other advantages. These and many other features and examples are described herein. These and many other features and examples are discussed herein.

Communication resources 1430 can include interconnection or network interface components or other suitable devices to communicate with one or more peripheral devices 1404 or one or more databases 1406 via network 1408. For example, communication resources 1430 can include wired communication components (e.g., for coupling via a universal serial bus), cellular communication components, near field communication components, Bluetooth® components (e.g., Bluetooth® Low Energy), Wi-Fi® components, and other communication components.

Instructions 1450A, 1450B, 1450C, 1450D, and/or 1450E can comprise software, a program, an application, an applet, an app, or other executable code for causing at least any of processors 1410 to perform any one or more of the methodologies discussed herein. Instructions 1450 can reside, completely or partially, within at least one of processors 1410 (e.g., within a cache memory), memory/storage devices 1420, or any suitable combination thereof. Furthermore, any portion of instructions 1450A-E can be transferred to hardware resources 1400 from any combination of peripheral devices 1404 or databases 1406. Accordingly, memory of processors 1410, memory/storage devices 1420, peripheral devices 1404, and databases 1406 are examples of computer-readable and machine-readable media.

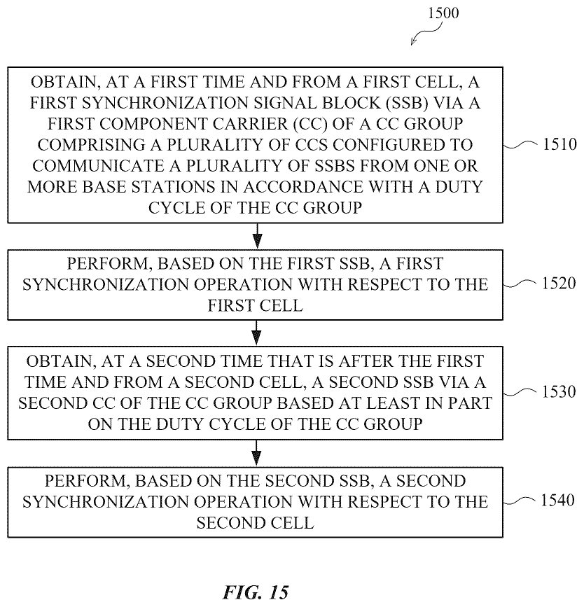

FIG. 15 is a diagram of an example process for staggering duty cycles across CCs of a CC group for SSB according to one or more implementations described herein. Process 1500 can be implemented by UE 210, baseband circuitry, or both. In some implementations, some or all of process 1500 can be performed by one or more other systems or devices, including one or more of the devices of FIG. 2. Additionally, process 1500 can include one or more fewer, additional, differently ordered and/or arranged operations than those shown in FIG. 15. In some implementations, some or all of the operations of process 1500 can be performed independently, successively, simultaneously, etc., of one or more of the other operations of process 1500. As such, the techniques described herein are not limited to a number, sequence, arrangement, timing, etc., of the operations or processes depicted in FIG. 15.

Process 1500 can include obtaining (e.g., receiving), at a first time and from a first cell, a first synchronization signal block (SSB) via a first component carrier (CC) of a CC group comprising a plurality of CCs configured to communicate a plurality of SSBs from one or more base stations in accordance with a duty cycle of the CC group (block 1510). Process 1500 can include performing, based on the first SSB, a first synchronization operation with respect to the first cell (block 1520). Process 1500 can include obtaining (e.g., receiving), at a second time that is after the first time and from a second cell, a second SSB via a second CC of the CC group based at least in part on the duty cycle of the CC group (block 1530). Process 1500 can include performing, based on the second SSB, a second synchronization operation with respect to the second cell (block 1540).

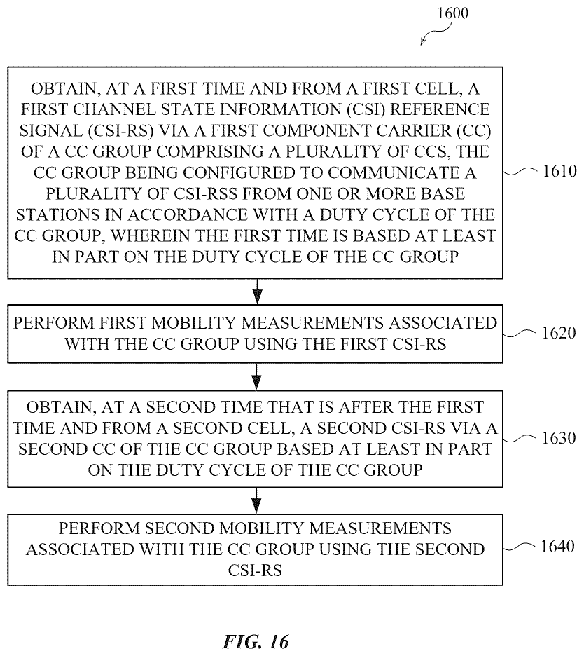

FIG. 16 is a diagram of an example process for staggering duty cycles across CCs of a CC group for CSI-RS according to one or more implementations described herein. Process 1600 can be implemented by UE 210, baseband circuitry, or both. In some implementations, some or all of process 1600 can be performed by one or more other systems or devices, including one or more of the devices of FIG. 2. Additionally, process 1600 can include one or more fewer, additional, differently ordered and/or arranged operations than those shown in FIG. 16. In some implementations, some or all of the operations of process 1600 can be performed independently, successively, simultaneously, etc., of one or more of the other operations of process 1600. As such, the techniques described herein are not limited to a number, sequence, arrangement, timing, etc., of the operations or processes depicted in FIG. 16.

Process 1600 can include obtaining (e.g., receiving), at a first time and from a first cell, a first channel state information (CSI) reference signal (CSI-RS) via a first component carrier (CC) of a CC group comprising a plurality of CCs, the CC group being configured to communicate a plurality of CSI-RSs from one or more base stations in accordance with a duty cycle of the CC group, wherein the first time is based at least in part on the duty cycle of the CC group (block 1610). Process 1600 can include performing first mobility measurements associated with the CC group using the first CSI-RS (block 1620). Process 1600 can include obtaining (e.g., receiving), at a second time that is after the first time and from a second cell, a second CSI-RS via a second CC of the CC group based at least in part on the duty cycle of the CC group (block 1630). Process 1600 can include performing second mobility measurements associated with the CC group using the second CSI-RS (block 1640).

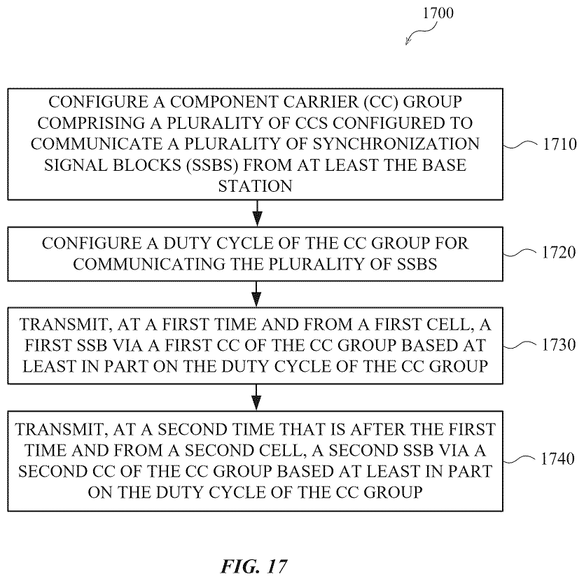

FIG. 17 is a diagram of an example process for staggering duty cycles across CCs of a CC group for SSB according to one or more implementations described herein. Process 1700 can be implemented by base station 222, or a network. In some implementations, some or all of process 1700 can be performed by one or more other systems or devices, including one or more of the devices of FIG. 2. Additionally, process 1700 can include one or more fewer, additional, differently ordered and/or arranged operations than those shown in FIG. 17. In some implementations, some or all of the operations of process 1700 can be performed independently, successively, simultaneously, etc., of one or more of the other operations of process 1700. As such, the techniques described herein are not limited to a number, sequence, arrangement, timing, etc., of the operations or processes depicted in FIG. 17.

Process 1700 can include configuring a component carrier (CC) group comprising a plurality of CCs configured to communicate a plurality of synchronization signal blocks (SSBs) from at least the base station (block 1710). Process 1700 can include configuring a duty cycle of the CC group for communicating the plurality of SSBs (block 1720). Process 1700 can include transmitting, at a first time and from a first cell, a first SSB via a first CC of the CC group based at least in part on the duty cycle of the CC group (block 1730). Process 1700 can include transmitting, at a second time that is after the first time and from a second cell, a second SSB via a second CC of the CC group based at least in part on the duty cycle of the CC group (block 1740).

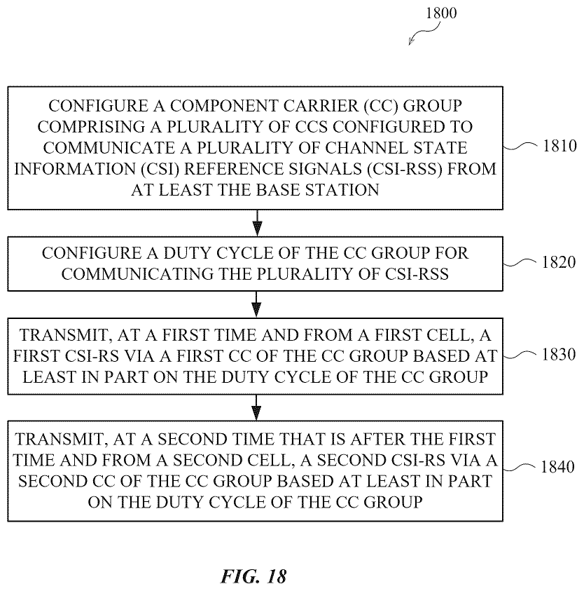

FIG. 18 is a diagram of an example process for staggering duty cycles across CCs of a CC group for CSI-RS according to one or more implementations described herein. Process 1800 can be implemented by base station 222, or a network. In some implementations, some or all of process 1800 can be performed by one or more other systems or devices, including one or more of the devices of FIG. 2. Additionally, process 1800 can include one or more fewer, additional, differently ordered and/or arranged operations than those shown in FIG. 18. In some implementations, some or all of the operations of process 1800 can be performed independently, successively, simultaneously, etc., of one or more of the other operations of process 1800. As such, the techniques described herein are not limited to a number, sequence, arrangement, timing, etc., of the operations or processes depicted in FIG. 18.

Process 1800 can include configuring a component carrier (CC) group comprising a plurality of CCs configured to communicate a plurality of channel state information (CSI) reference signals (CSI-RSs) from at least the base station (block 1810). Process 1800 can include configuring a duty cycle of the CC group for communicating the plurality of CSI-RSs (block 1820). Process 1800 can include transmitting, at a first time and from a first cell, a first CSI-RS via a first CC of the CC group based at least in part on the duty cycle of the CC group (block 1830). Process 1800 can include transmitting, at a second time that is after the first time and from a second cell, a second CSI-RS via a second CC of the CC group based at least in part on the duty cycle of the CC group (block 1840).

Examples and/or implementations herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which can also include one or more of the examples described herein, baseband circuitry (e.g., or a UE, such as UE 210) can comprise: a memory configured to store one or more instructions; and one or more processors configured to, when executing the one or more instructions, cause the baseband circuitry to: obtain (e.g., receive), at a first time and from a first cell, a first synchronization signal block (SSB) via a first component carrier (CC) of a CC group comprising a plurality of CCs configured to communicate a plurality of SSBs from one or more base stations in accordance with a duty cycle of the CC group; perform, based on the first SSB, a first synchronization operation with respect to the first cell; obtain (e.g., receive), at a second time that is after the first time and from a second cell, a second SSB via a second CC of the CC group based at least in part on the duty cycle of the CC group; and perform, based on the second SSB, a second synchronization operation with respect to the second cell.

In example 2, which can also include one or more of the examples described herein, the one or more processors are further configured to cause the baseband circuitry to: obtain an indication of the CC group and the duty cycle of the CC group from the one or more base stations, and wherein obtaining the first SSB and obtaining the second SSB is based at least in part on obtaining the indication of the CC group and the duty cycle of the CC group.

In example 3, which can also include one or more of the examples described herein, the one or more processors are further configured to cause the baseband circuitry to: determine the CC group and the duty cycle of the CC group based at least in part on obtaining the first SSB, and wherein obtaining the second SSB is based at least in part on determining the CC group and the duty cycle of the CC group.

In example 4, which can also include one or more of the examples described herein, the one or more processors are further configured to cause the baseband circuitry to: perform a wake-up procedure, and wherein obtaining the first SSB or obtaining the second SSB is based at least in part on performing the wake-up procedure.

In example 5, which can also include one or more of the examples described herein, to perform the second synchronization operation, the one or more processors are further configured to cause the baseband circuitry to: perform the second synchronization operation using the second SSB based at least in part on performing the wake-up procedure at a third time after the first time and before the second time.

In example 6, which can also include one or more of the examples described herein, the one or more processors are further configured to cause the baseband circuitry to: obtain, at a third time that is after the second time and from the first cell, a third SSB via the first CC of the CC group based at least in part on the duty cycle of the CC group.

In example 7, which can also include one or more of the examples described herein, the one or more processors are further configured to cause the baseband circuitry to: obtain, at a third time that is after the second time and from a third cell, a third SSB via a third CC of the CC group based at least in part on the duty cycle of the CC group.

In example 8, which can also include one or more of the examples described herein, the one or more processors are further configured to cause the baseband circuitry to: select the first CC based at least in part on determining a signal strength associated with each of the first CC and the second CC, and perform a third synchronization operation using the first SSB based at least in part on selecting the first CC and the first SSB being obtained via the first CC.

In example 9, which can also include one or more of the examples described herein, the baseband circuitry is in an IDLE mode for the first CC, and the one or more processors are further configured to cause the baseband circuitry to: perform a third synchronization operation using the second SSB.

In example 10, which can also include one or more of the examples described herein, the one or more processors are further configured to cause the baseband circuitry to: determine that the baseband circuitry is operating in an idle mode, and obtaining the first SSB and the second SSB is based at least in part on the baseband circuitry operating in the idle mode.

In example 11, which can also include one or more of the examples described herein, the first CC is associated with a first base station of the one or more base stations, the second CC is associated with a second base station of the one or more base stations, and to obtain the first SSB and the second SSB, the one or more processors are further configured to cause the baseband circuitry to: obtain the first SSB from the first base station via the first CC; and obtain the second SSB from the second base station via the second CC.

In example 12, which can also include one or more of the examples described herein, the first CC and the second CC are each associated with a first base station of the one or more base stations, and to obtain the first SSB and the second SSB, the one or more processors are further configured to cause the baseband circuitry to: obtain the first SSB from the first base station via the first CC; and obtain the second SSB from the first base station via the second CC.

In example 13, which can also include one or more of the examples described herein, for a duration between the first time and the second time, the plurality of CCs are configured not to communicate the plurality of SSBs.

In example 14, which can also include one or more of the examples described herein, the second SSB is not communicated during the first time; and the first SSB is not communicated during the second time.

In example 15, which can also include one or more of the examples described herein, the first SSB and the second SSB are consecutive SSBs of the plurality of SSBs according to the duty cycle of the CC group.

In example 16, which can also include one or more of the examples described herein, the first SSB and the second SSB are non-consecutive SSBs of the plurality of SSBs according to the duty cycle of the CC group.

In example 17, which can also include one or more of the examples described herein, baseband circuitry (e.g., or a UE, such as UE 210) can comprise: a memory configured to store one or more instructions; and one or more processors configured to, when executing the one or more instructions, cause the baseband circuitry to: obtain (e.g., receive), at a first time and from a first cell, a first channel state information (CSI) reference signal (CSI-RS) via a first CC of a CC group comprising a plurality of CCs, the CC group being configured to communicate a plurality of CSI-RSs from one or more base stations in accordance with a duty cycle of the CC group, wherein the first time is based at least in part on the duty cycle of the CC group; perform first mobility measurements associated with the CC group using the first CSI-RS; obtain (e.g., receive), at a second time that is after the first time and from a second cell, a second CSI-RS via a second CC of the CC group based at least in part on the duty cycle of the CC group; and perform second mobility measurements associated with the CC group using the second CSI-RS.

In example 18, which can also include one or more of the examples described herein, the one or more processors are further configured to cause the baseband circuitry to: determine mobility information associated with the CC group based at least in part on performing the first mobility measurements, the second mobility measurements, or both the first mobility measurements and the second mobility measurements.

In example 19, which can also include one or more of the examples described herein, the mobility information comprises: reference signal received power (RSRP) information, reference signal received quality (RSRQ) information, signal interference noise ratio (SINR) information, hysteresis information, offset information, or a combination thereof.

In example 20, which can also include one or more of the examples described herein, the one or more processors are further configured to cause the baseband circuitry to: transmit a mobility report to the one or more base stations based at least in part on the mobility information.

In example 21, which can also include one or more of the examples described herein, the one or more processors are further configured to cause the baseband circuitry to: detect a mobility event based at least in part on comparing the mobility information to one or more thresholds; and transmit a mobility report to the one or more base stations based at least in part on detecting the mobility event.

In example 22, which can also include one or more of the examples described herein, the one or more processors are further configured to cause the baseband circuitry to: obtain an indication of the one or more thresholds from the one or more base stations, and wherein comparing the mobility information to the one or more thresholds is based at least in part on obtaining the indication of the one or more thresholds.

In example 23, which can also include one or more of the examples described herein, to perform the first mobility measurements associated with the CC group, the one or more processors are further configured to cause the baseband circuitry to: perform mobility measurements for the first CC of the CC group using the first CSI-RS.

In example 24, which can also include one or more of the examples described herein, the one or more processors are further configured to cause the baseband circuitry to: perform third mobility measurements for the first CC and the second CC of the CC group using the first CSI-RS or the second CSI-RS.

In example 25, which can also include one or more of the examples described herein, to perform the third mobility measurements, the one or more processors are further configured to cause the baseband circuitry to: average the third mobility measurements for the first CC and the second CC of the CC group.

In example 26, which can also include one or more of the examples described herein, the one or more processors are further configured to cause the baseband circuitry to: obtain an indication of one or more CCs of the CC group associated with performing the first mobility measurements, the second mobility measurements, or both the first mobility measurements and the second mobility measurements, and wherein performing the first mobility measurements, the second mobility measurements, or both the first mobility measurements and the second mobility measurements, is based at least in part on obtaining the indication of the one or more CCs of the CC group.

In example 27, which can also include one or more of the examples described herein, the one or more processors are further configured to cause the baseband circuitry to: obtain, at a third time that is after the second time and from the first cell, a third CSI-RS via the first CC of the CC group based at least in part on the duty cycle of the CC group.

In example 28, which can also include one or more of the examples described herein, the one or more processors are further configured to cause the baseband circuitry to: obtain, at a third time that is after the second time and from a third cell, a third CSI-RS via a third CC of the CC group based at least in part on the duty cycle of the CC group.

In example 29, which can also include one or more of the examples described herein, the one or more processors are further configured to cause the baseband circuitry to: determine the baseband circuitry is operating in a connected mode, and wherein obtaining the first CSI-RS and the second CSI-RS is based at least in part on the baseband circuitry operating in the connected mode.

In example 30, which can also include one or more of the examples described herein, the first CC is associated with a first base station of the one or more base stations, the second CC is associated with a second base station of the one or more base station, and to obtain the first CSI-RS and the second CSI-RS, the one or more processors are further configured to cause the baseband circuitry to: obtain the first CSI-RS from the first base station via the first CC; and obtain the second CSI-RS from the second base station via the second CC.

In example 31, which can also include one or more of the examples described herein, the first CC and the second CC are each associated with a first base station of the one or more base stations, and to obtain the first CSI-RS and the second CSI-RS, the one or more processors are further configured to cause the baseband circuitry to: obtain the first CSI-RS from the first base station via the first CC; and obtain the second CSI-RS from the first base station via the second CC.

In example 32, which can also include one or more of the examples described herein, for a duration between the first time and the second time, the plurality of CCs are configured not to communicate the plurality of CSI-RSs.

In example 33, which can also include one or more of the examples described herein, the second CSI-RS is not communicated during the first time, and the first CSI-RS is not communicated during the second time.

In example 34, which can also include one or more of the examples described herein, the first CSI-RS and the second CSI-RS are consecutive CSI-RSs of the plurality of CSI-RSs according to the duty cycle of the CC group.

In example 35, which can also include one or more of the examples described herein, the first CSI-RS and the second CSI-RS are non-consecutive CSI-RSs of the plurality of CSI-RSs according to the duty cycle of the CC group.

In example 36, which can also include one or more of the examples described herein, a UE (e.g., UE 210) can comprise: a memory configured to store one or more instructions; and one or more processors configured to, when executing the one or more instructions, cause the UE to: receive, at a first time and from a first cell, a first SSB via a first CC of a CC group comprising a plurality of CCs configured to communicate a plurality of SSBs from one or more base stations in accordance with a duty cycle of the CC group; perform, based on the first SSB, a first synchronization operation with respect to the first cell; receive, at a second time that is after the first time and from a second cell, a second SSB via a second CC of the CC group based at least in part on the duty cycle of the CC group; and perform, based on the second SSB, a second synchronization operation with respect to the second cell.

In example 37, which can also include one or more of the examples described herein, a UE (e.g., UE 210) can comprise: a memory configured to store one or more instructions; and one or more processors configured to, when executing the one or more instructions, cause the UE to: receive, at a first time and from a first cell, a first CSI-RS via a first CC of a CC group comprising a plurality of CCs, the CC group being configured to communicate a plurality of CSI-RSs from one or more base stations in accordance with a duty cycle of the CC group, wherein the first time is based at least in part on the duty cycle of the CC group; perform first mobility measurements associated with the CC group using the first CSI-RS; receive, at a second time that is after the first time and from a second cell, a second CSI-RS via a second CC of the CC group based at least in part on the duty cycle of the CC group; and perform second mobility measurements associated with the CC group using the second CSI-RS.

In example 38, which can also include one or more of the examples described herein, a base station (e.g., a base station 222) can comprise: a memory configured to store one or more instructions; and one or more processors configured to, when executing the one or more instructions, cause the base station to: configure a CC group comprising a plurality of CCs configured to communicate a plurality of SSBs from at least the base station; configure a duty cycle of the CC group for communicating the plurality of SSBs; transmit, at a first time and from a first cell, a first SSB via a first CC of the CC group based at least in part on the duty cycle of the CC group; and transmit, at a second time that is after the first time and from a second cell, a second SSB via a second CC of the CC group based at least in part on the duty cycle of the CC group.

In example 39, which can also include one or more of the examples described herein, the one or more processors are further configured to cause the base station to: transmit an indication of the CC group and the duty cycle of the CC group.

In example 40, which can also include one or more of the examples described herein, the one or more processors are further configured to cause the base station to: transmit, at a third time that is after the second time and from the first cell, a third SSB via the first CC of the CC group based at least in part on the duty cycle of the CC group.

In example 41, which can also include one or more of the examples described herein, the one or more processors are further configured to cause the base station to: transmit, at a third time that is after the second time and from a third cell, a third SSB via a third CC of the CC group based at least in part on the duty cycle of the CC group.

In example 42, which can also include one or more of the examples described herein, for a duration between the first time and the second time, the base station is configured not to communicate the plurality of SSBs via the plurality of CCs.

In example 43, which can also include one or more of the examples described herein, the second SSB is not transmitted during the first time; and the first SSB is not transmitted during the second time.

In example 44, which can also include one or more of the examples described herein, the first SSB and the second SSB are consecutive SSBs of the plurality of SSBs according to the duty cycle of the CC group.

In example 45, which can also include one or more of the examples described herein, the first SSB and the second SSB are non-consecutive SSBs of the plurality of SSBs according to the duty cycle of the CC group.

In example 46, which can also include one or more of the examples described herein, a base station (e.g., a base station 222) can comprise: a memory configured to store one or more instructions; and one or more processors configured to, when executing the one or more instructions, cause the base station to: configure a component carrier (CC) group comprising a plurality of CCs configured to communicate a plurality of channel state information (CSI) reference signals (CSI-RSs) from at least the base station; configure a duty cycle of the CC group for communicating the plurality of CSI-RSs; transmit, at a first time and from a first cell, a first CSI-RS via a first CC of the CC group based at least in part on the duty cycle of the CC group; and transmit, at a second time that is after the first time and from a second cell, a second CSI-RS via a second CC of the CC group based at least in part on the duty cycle of the CC group.

In example 47, which can also include one or more of the examples described herein, the one or more processors are further configured to cause the base station to: receive a mobility report comprising mobility information.

In example 48, which can also include one or more of the examples described herein, the mobility information comprises: reference signal received power (RSRP) information, reference signal received quality (RSRQ) information, signal interference noise ratio (SINR) information, hysteresis information, offset information, or a combination thereof.

In example 49, which can also include one or more of the examples described herein, the one or more processors are further configured to cause the base station to: receive a mobility report indicating detection of a mobility event.

In example 50, which can also include one or more of the examples described herein, the one or more processors are further configured to cause the base station to: transmit an indication of one or more thresholds for detecting the mobility event, and wherein receiving the mobility report indicating detection of the mobility event is based at least in part on transmitting the indication of the one or more thresholds.

In example 51, which can also include one or more of the examples described herein, the one or more processors are further configured to cause the base station to: transmit an indication of one or more CCs of the CC group for performing mobility measurements.

In example 52, which can also include one or more of the examples described herein, the one or more processors are further configured to cause the base station to: transmit, at a third time that is after the second time and from the first cell, a third CSI-RS via the first CC of the CC group based at least in part on the duty cycle of the CC group.

In example 53, which can also include one or more of the examples described herein, the one or more processors are further configured to cause the base station to: transmit, at a third time that is after the second time and from a third cell, a third CSI-RS via a third CC of the CC group based at least in part on the duty cycle of the CC group.

In example 54, which can also include one or more of the examples described herein, for a duration between the first time and the second time, the base station is configured not to communicate the plurality of CSI-RSs via the plurality of CCs.

In example 55, which can also include one or more of the examples described herein, the second CSI-RS is not transmitted during the first time, and the first CSI-RS is not transmitted during the second time.

In example 56, which can also include one or more of the examples described herein, the first CSI-RS and the second CSI-RS are consecutive CSI-RSs of the plurality of CSI-RSs according to the duty cycle of the CC group.

In example 57, which can also include one or more of the examples described herein, the first CSI-RS and the second CSI-RS are non-consecutive CSI-RSs of the plurality of CSI-RSs according to the duty cycle of the CC group.

The examples discussed above also extend to method, computer-readable medium, and means-plus-function claims and implementations, any of which can include one or more of the features or operations of any one or combination of the examples mentioned above.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature can have been disclosed with respect to only one of several implementations, such feature can be combined with one or more other features of the other implementations as can be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. Baseband circuitry, comprising:
a memory configured to store one or more instructions; and
one or more processors configured to, when executing the one or more instructions, cause the baseband circuitry to:
obtain, at a first time and from a first cell, a first synchronization signal block (SSB) via a first component carrier (CC) of a CC group comprising a plurality of CCs configured to communicate a plurality of SSBs from one or more base stations in accordance with a duty cycle of the CC group;
perform, based on the first SSB, a first synchronization operation with respect to the first cell;
obtain, at a second time that is after the first time and from a second cell, a second SSB via a second CC of the CC group based at least in part on the duty cycle of the CC group; and
perform, based on the second SSB, a second synchronization operation with respect to the second cell.

2. The baseband circuitry of claim 1, wherein the one or more processors are further configured to cause the baseband circuitry to:
obtain an indication of the CC group and the duty cycle of the CC group from the one or more base stations, and
wherein obtaining the first SSB and obtaining the second SSB is based at least in part on obtaining the indication of the CC group and the duty cycle of the CC group.

3. The baseband circuitry of claim 1, wherein the one or more processors are further configured to cause the baseband circuitry to:
determine the CC group and the duty cycle of the CC group based at least in part on obtaining the first SSB, and
wherein obtaining the second SSB is based at least in part on determining the CC group and the duty cycle of the CC group.

4. The baseband circuitry of claim 1, wherein the one or more processors are further configured to cause the baseband circuitry to:
perform a wake-up procedure, and
wherein obtaining the first SSB or obtaining the second SSB is based at least in part on performing the wake-up procedure.

5. The baseband circuitry of claim 4, wherein, to perform the second synchronization operation, the one or more processors are configured to cause the baseband circuitry to:
perform the second synchronization operation using the second SSB based at least in part on performing the wake-up procedure at a third time after the first time and before the second time.

6. The baseband circuitry of claim 1, wherein the one or more processors are further configured to cause the baseband circuitry to:
obtain, at a third time that is after the second time and from the first cell, a third SSB via the first CC of the CC group based at least in part on the duty cycle of the CC group.

7. The baseband circuitry of claim 1, wherein the one or more processors are further configured to cause the baseband circuitry to:
obtain, at a third time that is after the second time and from a third cell, a third SSB via a third CC of the CC group based at least in part on the duty cycle of the CC group.

8. The baseband circuitry of claim 1, wherein the one or more processors are further configured to cause the baseband circuitry to:
select the first CC based at least in part on determining a signal strength associated with each of the first CC and the second CC, and
perform a third synchronization operation using the first SSB based at least in part on selecting the first CC and the first SSB being obtained via the first CC.

9. The baseband circuitry of claim 1, wherein the one or more processors are further configured to cause the baseband circuitry to:
determine that the baseband circuitry is operating in an idle mode, and obtaining the first SSB and the second SSB is based at least in part on the baseband circuitry operating in the idle mode.

10. The baseband circuitry of claim 1, wherein:
the first CC is associated with a first base station of the one or more base stations,
the second CC is associated with a second base station of the one or more base stations, and
to obtain the first SSB and the second SSB, the one or more processors are further configured to cause the baseband circuitry to:
obtain the first SSB from the first base station via the first CC; and
obtain the second SSB from the second base station via the second CC.

11. The baseband circuitry of claim 1, wherein:
the first CC and the second CC are each associated with a first base station of the one or more base stations, and
to obtain the first SSB and the second SSB, the one or more processors are further configured to cause the baseband circuitry to:
obtain the first SSB from the first base station via the first CC; and
obtain the second SSB from the first base station via the second CC.

12. A user equipment (UE), comprising:
a memory configured to store one or more instructions; and
one or more processors configured to, when executing the one or more instructions, cause the UE to:
obtain, at a first time and from a first cell, a first channel state information (CSI) reference signal (CSI-RS) via a first component carrier (CC) of a CC group comprising a plurality of CCs, the CC group being configured to communicate a plurality of CSI-RSs from one or more base stations in accordance with a duty cycle of the CC group, wherein the first time is based at least in part on the duty cycle of the CC group;
perform first mobility measurements associated with the CC group using the first CSI-RS;
obtain, at a second time that is after the first time and from a second cell, a second CSI-RS via a second CC of the CC group based at least in part on the duty cycle of the CC group; and
perform second mobility measurements associated with the CC group using the second CSI-RS.

13. The UE of claim 12, wherein the one or more processors are further configured to cause the UE to:
determine mobility information associated with the CC group based at least in part on performing the first mobility measurements, the second mobility measurements, or both the first mobility measurements and the second mobility measurements.

14. The UE of claim 13, wherein the one or more processors are further configured to cause the UE to:
transmit a mobility report to the one or more base stations based at least in part on the mobility information.

15. The UE of claim 13, wherein the one or more processors are further configured to cause the UE to:
detect a mobility event based at least in part on comparing the mobility information to one or more thresholds; and
transmit a mobility report to the one or more base stations based at least in part on detecting the mobility event.

16. The UE of claim 12, wherein the one or more processors are further configured to cause the UE to:
perform third mobility measurements for the first CC and the second CC of the CC group using the first CSI-RS or the second CSI-RS.

17. The UE of claim 16, wherein, to perform the third mobility measurements, the one or more processors are configured to cause the UE to:
average the third mobility measurements for the first CC and the second CC of the CC group.

18. The UE of claim 12, wherein the one or more processors are further configured to cause the UE to:
obtain an indication of one or more CCs of the CC group associated with performing the first mobility measurements, the second mobility measurements, or both the first mobility measurements and the second mobility measurements, and
wherein performing the first mobility measurements, the second mobility measurements, or both the first mobility measurements and the second mobility measurements, is based at least in part on obtaining the indication of the one or more CCs of the CC group.

19. The UE of claim 12, wherein the one or more processors are further configured to cause the UE to:
determine the baseband circuitry is operating in a connected mode, and
wherein obtaining the first CSI-RS and the second CSI-RS is based at least in part on the baseband circuitry operating in the connected mode.

20. A method for wireless communication by a user equipment (UE), comprising:
receiving, at a first time and from a first cell, a first synchronization signal block (SSB) via a first component carrier (CC) of a CC group comprising a plurality of CCs configured to communicate a plurality of SSBs from one or more base stations in accordance with a duty cycle of the CC group;
performing, based on the first SSB, a first synchronization operation with respect to the first cell;
receiving, at a second time that is after the first time and from a second cell, a second SSB via a second CC of the CC group based at least in part on the duty cycle of the CC group; and
performing, based on the second SSB, a second synchronization operation with respect to the second cell.
